(19) United States
(12) Patent Application Publication
(10) Pub. No.: US 2024/0343014 A1
(43) Pub. Date: Oct. 17, 2024

(54) DEVICE AND METHOD FOR MANUFACTURING CORRUGATED CARDBOARD

(71) Applicant: MITSUBISHI HEAVY INDUSTRIES MACHINERY SYSTEMS, LTD., Hyogo (JP)

(72) Inventors: Koki SAKAMOTO, Hyogo (JP); Hideki MIZUTANI, Hyogo (JP); Shuichi TAKEMOTO, Hyogo (JP); Yoshiaki NAKAMATSU, Hyogo (JP)

(21) Appl. No.: 18/294,865

(22) PCT Filed: Apr. 18, 2023
(86) PCT No.: PCT/JP2023/015522

§ 371 Date: Feb. 2, 2024

(30) Foreign Application Priority Data
Jun. 16, 2022 (JP) 2022-097346

(51) Int. Cl. B31F 1/28; B65H 19/18; B65H 26/02

(52) U.S. Cl. CPC B31F 1/2831; B65H 19/18; B65H 26/02; B65H 2511/13; B65H 2701/1762

(57) ABSTRACT

A device and a method for manufacturing a corrugated cardboard include a second paper splicing device that splices a succeeding sheet to a preceding sheet, which are a second sheet; a third paper splicing device that splices a succeeding sheet to a preceding sheet, which are a third sheet; a single-faced web splice detection unit that detects a third paper splice part of the third sheet, based on a thickness of a single-faced web in which the second sheet and the third sheet are attached to each another; and a control device that controls at least one of the paper splicing times of the second paper splicing device and the third paper splicing device so that the third paper splice part is placed on a downstream side of a second paper splice part of the second sheet in a sheet conveyance direction, at an attachment position of the second sheet and the third sheet.

### FIELD

The present disclosure relates to a device and a method for manufacturing a corrugated cardboard that manufactures a corrugated cardboard in which a bottom liner, a corrugated inner core, and a top liner are attached to one another.

### BACKGROUND

A corrugating machine serving as a device for manufacturing a corrugated cardboard includes a single facer and a double facer. The single facer forms a single-faced web by processing a medium into a corrugated shape, and attaching a top liner thereto. The double facer forms a single-wall corrugated cardboard by attaching a bottom liner to the single-faced web. A continuous single-wall corrugated cardboard manufactured by the double facer is cut into a predetermined width by a slitter scorer, cut into a predetermined length by a cutoff device, and is manufactured into a corrugated cardboard sheet.

The bottom liner, the medium, and the top liner are sheets each supplied from a roll of paper held in a mill roll stand. The mill roll stand holds a plurality of rolls of paper, and if the roll of paper that is supplying the sheet is running short, the mill roll stand can continuously reel out the sheet, by splicing the sheet of the roll of paper standing by, using a splicer. However, the paper splice part of the sheet is a defective part that cannot be used as a product. Hence, it is preferable to detect and remove the paper splice part while manufacturing the corrugated cardboard. Moreover, at a bridge that retains the single-faced web of a predetermined length from an exit of the single facer to an entrance of the double facer, the length on bridge of the single-faced web is calculated on the basis of the moving distance of the paper splice part of the sheet.

Conventionally, a metal sheet such as aluminum is attached to a paper splice part of the sheet, and the paper splice part is detected by a metal sensor through the metal sheet. However, for example, if the sheet meanders while being conveyed, the metal sensor may not be able to detect the metal sheet, and the paper splice part may be shipped out as a product with the metal sheet. For example, to solve the above problems, a device is disclosed in the following Patent Literatures 1 and 2. The device for manufacturing a corrugated cardboard disclosed in Patent Literatures 1 and 2 cuts and removes a paper splice part of a sheet, after detecting the position of the paper splice part from the thickness of the corrugated cardboard sheet.

### CITATION LIST

### Patent Literature

Patent Literature 1: Japanese Patent Application Laid-open No. 2009-113895
Patent Literature 2: Japanese Patent Application Laid-open No. 2010-105772

### SUMMARY

### Technical Problem

Incidentally, while manufacturing corrugated cardboards, lots are changed, to change the corrugated cardboard sheet to be manufactured to a different type. For example, each splicer provided corresponding to the bottom liner, the medium, and the top liner splices a different type of bottom liner, medium, and liner to the bottom liner, the medium, and the top liner that have been fed out. Then, when the single facer forms a single-faced web by attaching the corrugated medium and the top liner, the paper splice part of the medium becomes double-layered. Hence, it becomes difficult to form a proper waveform by the single facer, and an adhesion failure with the top liner may occur.

The corrugating machine is provided with a bridge to retain a single-faced web of a predetermined length, from the exit of the single facer to the entrance of the double facer. For example, the length on bridge of the single-faced web at the bridge is calculated, on the basis of the moving distance of the single-faced web obtained by detecting a paper splice part of the top liner on the upstream side of the bridge, and then detecting the paper splice part of the top liner on the downstream side of the bridge. In this case, the paper splice part of the top liner is detected by a difference between the thickness of the single-faced web at a location where the paper splice part of the top liner is not present, and the thickness of the single-faced web at a location where the paper splice part of the top liner is present. However, if an adhesion failure of the medium and the top liner occurs at the position of the paper splice part of the medium, while the paper splice part of the medium precedes the paper splice part of the top liner, the paper splice part of the top liner is obstructed by the adhesion failure, and it is not possible to properly detect the thickness of the single-faced web. Therefore, it is not possible to detect the paper splice part of the top liner in the single-faced web on the downstream side of the bridge, and calculate the length on bridge.

An object of the present disclosure is to solve the above-described problems, and to provide a device and a method for manufacturing a corrugated cardboard that suppresses obstructed detection of a paper splice part of a second sheet, due to an adhesion failure of a medium and a top liner.

### Solution to Problem

In order to achieve the object, a device for manufacturing a corrugated cardboard according to the present disclosure is for manufacturing a corrugated cardboard to be conveyed in which a first sheet, a corrugated second sheet, and a third sheet are attached to one another, and includes: a second paper splicing device that splices a succeeding sheet to a preceding sheet, which are the second sheet; a third paper splicing device that splices a succeeding sheet to a preceding sheet, which are the third sheet; a single-faced web splice detection unit that detects a third paper splice part of the third sheet, based on a thickness of a single-faced web in which the second sheet and the third sheet are attached to each another; and a control device that controls at least one of paper splicing times of the second paper splicing device and the third paper splicing device so that the third paper splice part is placed on a downstream side of a second paper splice part of the second sheet in a sheet conveyance direction, at an attachment position of the second sheet and the third sheet.

Further, a method for manufacturing a corrugated cardboard according to the present disclosure is for manufacturing a corrugated cardboard in which a first sheet, a corrugated second sheet, and a third sheet are attached to one another, and includes the steps of: splicing a succeeding sheet to a preceding sheet, which are the second sheet; splicing a succeeding sheet to a preceding sheet, which are the third sheet; controlling at least one of paper splicing times of the second sheet and the third sheet so that a third paper splice part of the third sheet is placed on a downstream side of a second paper splice part of the second sheet in a sheet conveyance direction, at an attachment position of the second sheet and the third sheet; and detecting the third paper splice part based on a thickness of a single-faced web in which the second sheet and the third sheet are attached to each another.

### Advantageous Effects of Invention

According to a device and a method for manufacturing a corrugated cardboard of the present disclosure, it is possible to suppress obstructed detection of a paper splice part of the second sheet, due to an adhesion failure of the medium and the top liner.

### BRIEF DESCRIPTION OF DRAWINGS

FIG. 1 is a schematic diagram illustrating a corrugating machine of the present embodiment.

FIG. 2 is a schematic configuration diagram illustrating a device for manufacturing a corrugated cardboard of the present embodiment.

FIG. 3 is a schematic configuration diagram illustrating a processing flow of the device for manufacturing the corrugated cardboard of the present embodiment.

FIG. 4 is a schematic diagram illustrating a method for splicing sheets.

FIG. 5 is a schematic diagram illustrating a sheet splice detection unit.

FIG. 6 is a schematic diagram illustrating a single-faced web splice detection unit.

FIG. 7 is a schematic diagram illustrating a corrugation deformation device.

FIG. 8 is a schematic diagram of the periphery of a single facer used for explaining a flow of a medium, a top liner, and a single-faced web.

FIG. 9 is a schematic diagram of the periphery of a double facer used for explaining a flow of a bottom liner and a single-faced web.

FIG. 10 is a schematic diagram illustrating a single-faced web.

FIG. 11 is a schematic diagram illustrating a paper splice part of the single-faced web.

FIG. 12 is a schematic diagram illustrating a defect in the paper splice part of the single-faced web.

FIG. 13 is a schematic diagram illustrating a corrugation deformed part in the single-faced web.

FIG. 14 is a flowchart illustrating a method for manufacturing a corrugated cardboard.

### DESCRIPTION OF EMBODIMENTS

Hereinafter, preferred embodiments of the present disclosure will be described in detail with reference to the accompanying drawings. However, the present disclosure is not limited to the embodiment, and when there are a plurality of embodiments, the present disclosure also includes those configured by combining the embodiments. Moreover, components in the embodiment include those easily conceivable by those skilled in the art, those substantially the same, and those that fall within what is called the range of equivalents.

### Present Embodiment

### <Schematic Configuration of Corrugating Machine>

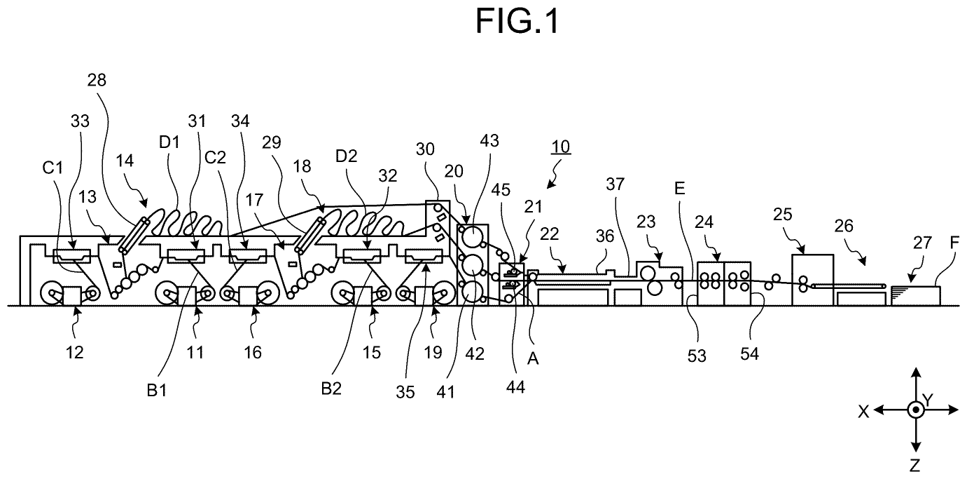

A device for manufacturing a corrugated cardboard of the present embodiment is applied to a corrugating machine. FIG. 1 is a schematic diagram illustrating a corrugating machine. In the following description, the longitudinal direction of the corrugating machine is the X direction, the horizontal direction orthogonal to the longitudinal direction of the corrugating machine (X direction) is the Y direction (width direction of the corrugated cardboard), and the vertical direction orthogonal to the longitudinal direction (X direction) of the corrugating machine is the Z direction (thickness direction of the corrugated cardboard). Moreover, a first sheet corresponds to a bottom liner A, a second sheet corresponds to mediums B1 and B2, and a third sheet corresponds to top liners C1 and C2.

As illustrated in FIG. 1, a corrugating machine 10 first produces a single-faced web D1 by attaching the top liner C1 to the corrugated medium B1, and also produces a single-faced web D2 by attaching the top liner C2 to the corrugated medium B2. Next, a continuous multiple single-wall corrugated cardboard is manufactured by attaching the top liner C2 of the single-faced web D2 to the medium B1 of the manufactured single-faced web D1, and attaching the bottom liner A to the medium B2 of the single-sided cardboard sheet D2. Then, a plate-shaped multiple single-wall corrugated cardboard is manufactured, by cutting the continuous multiple single-wall corrugated cardboard into a predetermined length.

Moreover, the corrugating machine 10 can produce a single-wall corrugated cardboard by attaching the single-faced web D2 or the single-faced web D1 to the bottom liner A. Furthermore, the corrugating machine 10 can also produce a multiple single-wall corrugated cardboard, by attaching the single-faced web D1, the single-faced web D2, and the bottom liner A to one another. Consequently, in the following description, the double-faced corrugated cardboard sheet and the multiple single-wall corrugated cardboard are collectively referred to as a single-wall corrugated cardboard E. Moreover, the plate-shaped single-wall corrugated cardboard and the plate-shaped multiple single-wall corrugated cardboard are collectively referred to as a single-wall corrugated cardboard F.

The corrugating machine 10 includes a mill roll stand 11 for the medium B1, a mill roll stand 12 for the top liner C1, a single facer 13, a bridge 14, a mill roll stand 15 for the medium B2, a mill roll stand 16 for the top liner C2, a single facer 17, a bridge 18, a mill roll stand 19 for the bottom liner A, a preheater 20, a glue machine 21, a double facer 22, a rotary shear 23, a slitter scorer 24, a cutoff 25, a waste removing device 26, and a stacker 27.

Rolls of paper in which the mediums B1 and B2 are each wound in a roll are provided on both sides of the mill roll stands 11 and 15 in the X direction, and splicers (second paper splicing devices) 31 and 32 used for splicing are provided between the rolls of paper. When paper is supplied from one roll of paper, the other roll of paper is loaded and prepared for splicing. When the one roll of paper is about to run out, the splicers 31 and 32 splice the other roll of paper to the one roll of paper. Consequently, the mediums B1 and B2 are continuously supplied from each of the mill roll stands 11 and 15 toward the downstream side.

Rolls of paper in which the top liners C1 and C2 are each wound in a roll are provided on both sides of the mill roll stands 12 and 16 in the X direction, and splicers (third paper splicing devices) 33 and 34 used for splicing are provided between the rolls of paper. When paper is supplied from one roll of paper, the other roll of paper is loaded and prepared for splicing. When the one roll of paper is about to run out, the splicers 33 and 34 splice the other roll of paper to the one roll of paper. Consequently, the top liners C1 and C2 are continuously supplied from each of the mill roll stands 12 and 16 toward the downstream side.

The mediums B1 and B2 reeled out from the mill roll stands 11 and 15, and the top liners C1 and C2 reeled out from the mill roll stands 12 and 16 are each preheated by a preheater, which is not illustrated. Each preheater includes a heating roll into which steam is supplied. By being wound around the heating roll while being conveyed, the mediums B1 and B2 and the top liners C1 and C2 are heated to a predetermined temperature.

The single facer 13 forms the single-faced web D1, by processing the heated medium B1 into a corrugated shape, applying glue to the corrugation tops, and attaching the heated top liner C1 to the medium B1. The single facer 13 includes a take-up conveyor 28 at the exit part of the single-faced web D1. The take-up conveyor 28 conveys the single-faced web D1 formed by the single facer 13 to the bridge 14. The bridge 14 temporarily retains the single-faced web D1, to absorb the speed difference between the single facer 13 and the double facer 22.

The single facer 17 forms the single-faced web D2, by processing the heated medium B2 into a corrugated shape, applying glue to the corrugation tops, and attaching the heated top liner C2 to the medium B2. The single facer 17 includes a take-up conveyor 29 at the exit part of the single-faced web D2. The take-up conveyor 28 conveys the single-faced web D2 formed by the single facer 17 to the bridge 18. The bridge 18 temporarily retains the single-faced web D2, to absorb the speed difference between the single facer 17 and the double facer 22.

Moreover, a paper guide device 30 is provided at the exit part of the bridge 14 and the bridge 18. The paper guide device 30 adjusts the positions of the single-faced web D1 and the single-faced web D2 in the Y direction, between the bridge 14 and the bridge 18, and the double facer 22.

Rolls of paper in which the bottom liner A is wound in a roll are provided on both sides of the mill roll stand 19 in the X direction, and a splicer (first paper splicing device) 35 used for splicing is provided between the rolls of paper. When paper is supplied from one roll of paper, the other roll of paper is loaded and prepared for splicing. When the one roll of paper is about to run out, the splicer splices the other roll of paper to the one roll of paper. Consequently, the bottom liner A is continuously supplied from the mill roll stand 19 toward the downstream side.

The preheater 20 includes three preheating rolls 41, 42, and 43 arranged side by side in the Z direction. The preheating roll 41 heats the bottom liner A, the preheating roll 42 heats the single-faced web D2, and the preheating roll 43 heats the single-faced web D1. Each of the preheating rolls 41, 42, and 43 includes a winding amount adjusting device (not illustrated), and is heated to a predetermined temperature when steam is supplied to the inside thereof. When the bottom liner A, the single-faced web D2, and the single-faced web D1 are wound therearound, the preheating rolls 41, 42, and 43 preheat the bottom liner A, the single-faced web D2, and the single-faced web D1.

In the glue machine 21, gluing rolls 44 and 45 are arranged side by side in the Z direction. The gluing roll 44 comes into contact with the top part of the step of the medium B2 in the single-faced web D2 that has been heated by the preheating roll 42 for gluing. The gluing roll 45 comes into contact with the top part of the step of the medium B1 in the single-faced web D1 that has been heated by the preheating roll 43 for gluing. The single-faced webs D1 and D2 to which glue is applied by the glue machine 21 are transferred to the double facer 22 in the next process. The bottom liner A heated by the preheating roll 41 is also transferred to the double facer 22 through the glue machine 21.

The double facer 22 includes a heating section 36 on the upstream side and a cooling section 37 on the downstream side, along the running line of each of the single-faced webs D1 and D2 and the bottom liner A. The single-faced webs D1 and D2 and the bottom liner A glued by the glue machine 21, are conveyed between a pressurize belt and a hot plate in the heating section 36, and are transferred toward the cooling section 37 while being integrated and overlapped with one another. During the transfer, each of the single-faced webs D1 and D2 and the bottom liner A are heated while being pressurized, and attached to one another to form a continuous single-wall corrugated cardboard E. The single-wall corrugated cardboard E is then naturally cooled while being conveyed.

The single-wall corrugated cardboard E produced by the double facer 22 is transferred to the slitter scorer 24. The slitter scorer 24 cuts the wide single-wall corrugated cardboard E along the X direction to have a predetermined width, and also processes a box making machine extending in the X direction. The slitter scorer 24 includes a first slitter scorer unit 53 and a second slitter scorer unit 54 having a substantially identical structure that are aligned along the X direction of the single-wall corrugated cardboard E. The wide single-wall corrugated cardboard E is cut by the slitter scorer 24 to form a single-wall corrugated cardboard E of a predetermined width.

The cutoff 25 cuts the single-wall corrugated cardboard E cut in the X direction by the slitter scorer 24 along the Y direction, to form a plate-shaped single-wall corrugated cardboard F with a predetermined length. The waste removing device 26 removes a single-wall corrugated cardboard F that is determined to be waste (a defective product) by a defective detection device, which will be described below, from the conveyance line. Although not illustrated, the waste removing device 26 includes a discharge conveyor and a distribution roll. When a plate-shaped single-wall corrugated cardboard F that is determined to be a defective product is conveyed, the distribution roll descends to distribute and discharge the defective plate-shaped single-wall corrugated cardboard F to the discharge conveyor. The stacker 27 stacks single-wall corrugated cardboards F that are determined as non-defective products, and discharges them to the outside of the machine as products.

### <Detailed Configuration of Corrugating Machine>

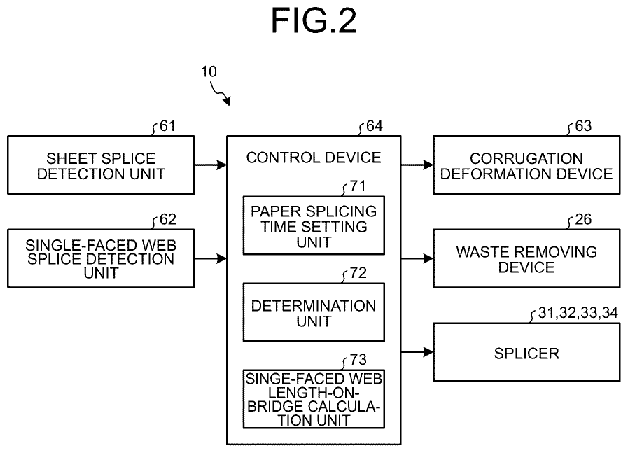

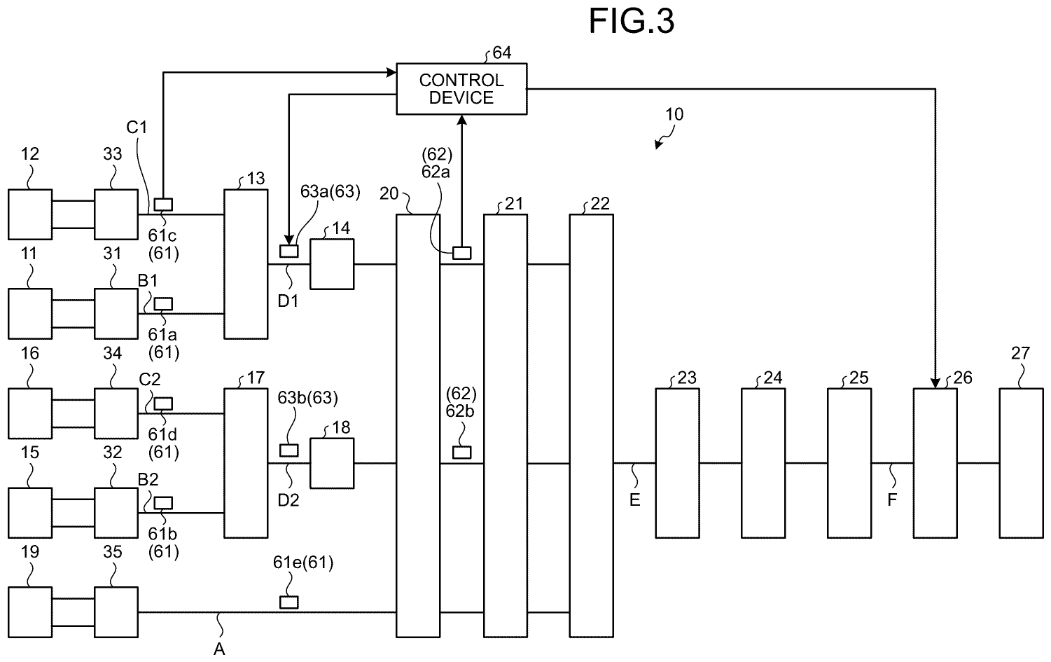

The configuration of a device for manufacturing a corrugated cardboard of the present embodiment will be described. FIG. 2 is a schematic configuration diagram illustrating the device for manufacturing a corrugated cardboard of the present embodiment. FIG. 3 is a schematic configuration diagram illustrating a processing flow of the device for manufacturing the corrugated cardboard of the present embodiment.

The corrugating machine 10 conveys the bottom liner A, the corrugated mediums B1 and B2, and the top liners C1 and C2 one by one, forms the single-faced webs D1 and D2 by attaching the corrugated mediums B1 and B2 and the top liners C1 and C2 to one another, and forms the single-wall corrugated cardboard E by attaching the bottom liner A to the single-faced webs D1 and D2.

As illustrated in FIG. 2, the corrugating machine 10 includes a sheet splice detection unit 61, a single-faced web splice detection unit 62, a corrugation deformation device 63, and a control device 64.

The sheet splice detection unit 61 is disposed between a sheet splicing position and a sheet attachment position in the sheet conveyance direction (one side of the X direction). In this example, the sheet splicing position is a position where the preceding sheets and the succeeding sheets of the bottom liner A, the mediums B1 and B2, and the top liners C1 and C2 are connected to one another. The sheet attachment position is a position where the corrugated mediums B1 and B2 and the top liners C1 and C2 are attached to one another, or where the bottom liner A and the single-faced webs D1 and D2 are attached to one another. The sheet splice detection unit 61 detects a paper splice part on the basis of the shape of the sheet. Specifically, the sheet splice detection unit 61 detects the paper splice part on the basis of the sheet thickness of each of the bottom liner A, the mediums B1 and B2, and the top liners C1 and C2.

The single-faced web splice detection unit 62 is disposed between a sheet retaining position and the sheet attachment position in the sheet conveyance direction. In this example, the sheet retaining position is a position where the single-faced webs D1 and D2 are retained, and the sheet attachment position is a position where the bottom liner A and the single-faced webs D1 and D2 are attached to one another. The single-faced web splice detection unit 62 detects a paper splice part on the basis of the shape of the sheet. Specifically, the single-faced web splice detection unit 62 detects the paper splice part on the basis of the sheet thicknesses of the single-faced webs D1 and D2.

The corrugation deformation device 63 is disposed between the sheet attachment position and the sheet retaining position in the sheet conveyance direction. In this example, the sheet attachment position is a position where the corrugated mediums B1 and B2 and the top liners C1 and C2 are attached to one another, and the sheet retaining position is a position where the single-faced webs D1 and D2 are retained. The corrugation deformation device 63 forms a corrugation deformed part, by deforming the corrugations that are formed by corrugating the mediums B1 and B2. Specifically, the corrugation deformation device 63 forms the corrugation deformed part, by crushing and deforming the corrugations of the mediums B1 and B2 that form the single-faced webs D1 and D2.

Moreover, the single-faced web splice detection unit 62 detects the corrugation deformed part formed by the corrugation deformation device 63 in the single-faced webs D1 and D2. Furthermore, the single-faced web splice detection unit 62 detects a corrugation deformed part (defective part) other than that formed by the corrugation deformation device 63 in the single-faced webs D1 and D2.

At the attachment position of the corrugated mediums B1 and B2 and the top liners C1 and C2, the control device 64 controls at least one of the paper splicing times of the splicers 31 and 32 and the splicers 33 and 34 such that the paper splice part (third paper splice part) of the top liners C1 and C2 is placed on the downstream side of the paper splice part (second paper splice part) of the mediums B1 and B2 in the sheet conveyance direction. Moreover, the control device 64 controls the operation time of the waste removing device 26 on the basis of position information on the paper splice part and the corrugation deformed part detected by the sheet splice detection unit 61 and the single-faced web splice detection unit 62. In this example, the control device 64 is a controller, and, for example, is implemented when a central processing unit (CPU), a micro processing unit (MPU), or the like executes various computer programs stored in a storage unit, using a RAM as a work area.

The processing flow of the corrugating machine 10 will now be described. As illustrated in FIG. 2 and FIG. 3, the sheet splice detection unit 61 detects a paper splice part of each of the bottom liner A, the mediums B1 and B2, and the top liners C1 and C2. The mediums B1 and B2 are reeled out from the mill roll stands 11 and 15, and are conveyed to the single facers 13 and 17 through the splicers 31 and 32. The top liners C1 and C2 are reeled out from the mill roll stands 12 and 16, and are conveyed to the single facers 13 and 17 through the splicers 33 and 34. The bottom liner A is reeled out from the mill roll stand 19, and is conveyed to the preheater 20 through the splicer 35.

The sheet splice detection unit 61 includes five ultrasonic sensors 61a, 61b, 61c, 61d, and 61e. The ultrasonic sensors 61a and 61c are disposed between the splicers 31 and 33 and the single facer 13. The ultrasonic sensors 61b and 61d are disposed between the splicers 32 and 34 and the single facer 17. The ultrasonic sensor 61e is disposed between the splicer 35 and the preheater 20. The ultrasonic sensors 61a, 61b, 61c, 61d, and 61e are connected to the control device 64, and output the detection results to the control device 64.

The single-faced web splice detection unit 62 detects the paper splice part and the corrugation deformed part on the basis of the sheet thicknesses of the single-faced webs D1 and D2. The single-faced web D1 is conveyed from the single facer 13 to the double facer 22, via the bridge 14, the preheater 20, and the glue machine 21. The single-faced web D2 is conveyed from the single facer 17 to the double facer 22, via the bridge 18, the preheater 20, and the glue machine 21.

The single-faced web splice detection unit 62 includes two laser displacement sensors 62a and 62b. The laser displacement sensors 62a and 62b are disposed between the preheater 20 and the glue machine 21. The laser displacement sensors 62a and 62b are disposed away from a surface on which the bottom liner A is attached to the mediums B1 and B2 in the single-faced webs D1 and D2, by a predetermined distance. The laser displacement sensors 62a and 62b are connected to the control device 64, and output the detection results to the control device 64.

The corrugation deformation device 63 is connected to the control device 64, and the control device 64 controls the operation of the corrugation deformation device 63. The control device 64 activates the corrugation deformation device 63, and forms a corrugation deformed part by deforming the corrugations of the mediums B1 and B2 in the single-faced webs D1 and D2. The corrugation deformation device 63 includes two crushing devices 63a and 63b. The crushing devices 63a and 63b are disposed between the single facer 13 and the bridge 14 and between the single facer 17 and the bridge 18, respectively.

The crushing device 63a is movably disposed on a position away from the top liner C1 that forms the single-faced web D1 by a predetermined distance. The crushing device 63a moves to come into contact with the single-faced web D1, and forms a corrugation deformed part by crushing the corrugated medium B1 in the single-faced web D1. The crushing device 63b is movably disposed on a position away from the top liner C2 that forms the single-faced web D2 by a predetermined distance. The crushing device 63b moves to come into contact with the single-faced web D2, and forms a corrugation deformed part by crushing the corrugated medium B2 in the single-faced web D2.

The control device 64 controls the paper splicing times in the splicers 31, 32, 33, 34, and 35 when the lots are changed for changing the type (width, thickness, paper quality, and the like) of the corrugated cardboard to be manufactured. In this process, at the attachment position of the mediums B1 and B2 and the top liners C1 and C2 in the single facers 13 and 17, the control device 64 adjusts the paper splicing times of the splicers 31 and 32 and the splicers 33 and 34 such that the paper splice parts of the top liners C1 and C2 are placed on the downstream side in the sheet conveyance direction preceding the paper splice parts of the mediums B1 and B2.

Moreover, when splicing is performed when the lots are changed or due to a shortage of roll of paper, the control device 64 calculates lengths of the single-faced webs D1 and D2 at the bridges 14 and 18, on the basis of the positions of the paper splice parts of the top liners C1 and C2 detected by the sheet splice detection unit 61, and the positions of the paper splice parts of the top liners C1 and C2 in the single-faced webs D1 and D2 detected by the single-faced web splice detection unit 62.

Furthermore, when the corrugating machine 10 starts operating, the control device 64 operates the corrugation deformation device 63 to form a corrugation deformed parts in the single-faced webs D1 and D2. Then, the control device 64 calculates the lengths of the single-faced webs D1 and D2 at the bridges 14 and 18, on the basis of positions of the corrugation deformed parts formed by the corrugation deformation device 63 in the single-faced webs D1 and D2, and positions of the corrugation deformed parts detected by the single-faced web splice detection unit 62 in the single-faced webs D1 and D2.

Still furthermore, the control device 64 tracks the paper splice parts in the bottom liner A, the mediums B1 and B2, and the top liners C1 and C2 detected by the sheet splice detection unit 61, and the corrugation deformed part detected by the single-faced web splice detection unit 62. The control device 64 controls the operation time of the waste removing device 26 on the basis of the position information on the paper splice part and the corrugation deformed part.

### <Sheet Splice Detection Unit>

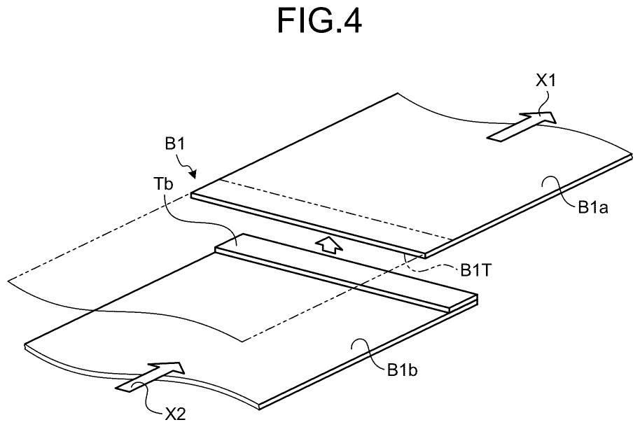

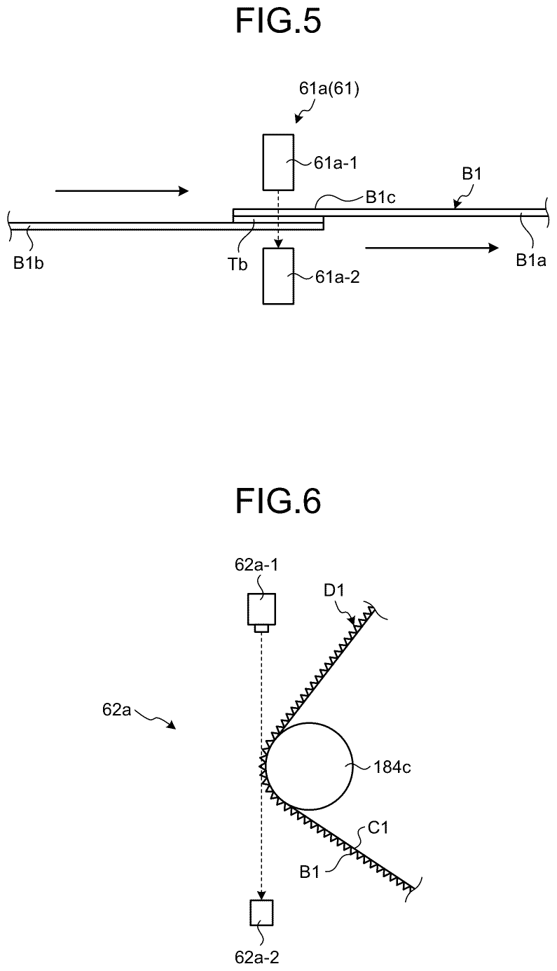

FIG. 4 is a schematic diagram illustrating a method for splicing sheets. FIG. 5 is a schematic diagram illustrating the sheet splice detection unit.

As illustrated in FIG. 3 and FIG. 4, the medium B1 is reeled out from the mill roll stand 11, when one of the rolls of paper is rotated. In this process, when one of the rolls of paper decreases and becomes short, or when the lots need to be changed, the medium B1 is spliced. That is, when one roll of paper is rotated and a preceding sheet B1a of the medium B1 is being reeled out, the splicer 31 rotates the other roll of paper at the same speed to reel out a succeeding sheet B1b of the medium B1, and connects the succeeding sheet B1b to the preceding sheet Bia. Consequently, the mill roll stand 11 can continuously reel out the medium B1.

The splicing of the medium B1 will now be described in detail. The preceding sheet Bia of the medium B1 runs along a sheet conveyance direction X1, and the succeeding sheet B1b runs at the same speed along a sheet conveyance direction X2. In this process, a double-sided tape Tb serving as an adhesive is attached to the surface of the succeeding sheet B1b, on the side facing the preceding sheet Bia on the cut tip end part. At a predetermined timing, the preceding sheet Bia and the succeeding sheet B1b are pressed together with the double-sided tape Tb interposed therebetween. Then, the double-sided tape Tb of the succeeding sheet B1b is crimped to an attaching part B1T of the preceding sheet Bia, and the succeeding sheet B1b is connected to the preceding sheet Bia. At the same time as this operation, the preceding sheet Bia is cut on the upstream side of the paper splice part with the succeeding sheet B1b.

As illustrated in FIG. 5, on the medium B1, a paper splice part Bic is formed by connecting the rear end part of the preceding sheet Bia and the tip end part of the succeeding sheet B1b with the double-sided tape Tb. The paper splice part Bic is formed when the lower surface of the rear end part of the preceding sheet Bia and the upper surface of the tip end part of the succeeding sheet B1b are connected by the double-sided tape Tb in an overlapping manner. Consequently, the thickness of the paper splice part Bic is the sum of the thickness of the preceding sheet Bia, the thickness of the succeeding sheet B1b, and the thickness of the double-sided tape Tb. That is, the thickness of the paper splice part Bic is thicker than the thickness of the preceding sheet B1a or the thickness of the succeeding sheet B1b.

The sheet splice detection unit 61 includes the ultrasonic sensor 61a. The ultrasonic sensor 61a includes a transmission unit 61a-1 and a reception unit 61a-2. The transmission unit 61a-1 is disposed on the upper surface side of the medium B1 to be conveyed, and the reception unit 61a-2 is disposed on the lower surface side of the medium B1 to be conveyed. The transmission unit 61a-1 and the reception unit 61a-2 are disposed so as to face each other in the vertical direction.

The transmission unit 61a-1 transmits ultrasonic waves toward the medium B1, and the reception unit 61a-2 receives the ultrasonic waves transmitted through the medium B1. In this process, the ultrasonic waves transmitted from the transmission unit 61a-1 are attenuated while passing through the medium B1, and the reception unit 61a-2 receives the attenuated ultrasonic waves. In the medium B1, the thickness of the paper splice part B1c is thicker than the thicknesses of the preceding sheet B1a and the succeeding sheet B1b. Consequently, in the medium B1, the attenuation amount of the ultrasonic waves of the paper splice part B1c is greater than the attenuation amounts of the ultrasonic waves of the preceding sheet B1a and the succeeding sheet B1b. The ultrasonic sensor 61a outputs the level of the ultrasonic waves received by the reception unit 61a-2 to the control device 64. The control device 64 detects the paper splice part Bic on the basis of the level of the ultrasonic waves input from the ultrasonic sensor 61a.

That is, not only the level of the ultrasonic waves transmitted through the preceding sheet B1a and the succeeding sheet B1b, but also the level of the ultrasonic waves transmitted through the paper splice part B1c is measured in advance. A determination value serving as a threshold is set between the level of the ultrasonic waves transmitted through the preceding sheet B1a and the succeeding sheet B1b, and the level of the ultrasonic waves transmitted through the paper splice part Bic. Then, the control device 64 detects the paper splice part B1c, by comparing the level of the ultrasonic waves input from the ultrasonic sensor 61a and the determination value. That is to say, when the level of the ultrasonic waves input from the ultrasonic sensor 61a exceeds the determination value, the control device 64 determines the part as the paper splice part B1c.

The ultrasonic sensor 61a that detects the paper splice part B1c of the medium B1 has been described. The same applies to the paper splice parts of the bottom liner A, the medium B2, and the top liners C1 and C2, and the ultrasonic sensors 61b, 61c, 61d, and 61e.

Moreover, the sheet splice detection unit 61 is not limited to being configured by the ultrasonic sensor 61a. For example, the sheet splice detection unit 61 may be configured by a laser displacement sensor. That is, the laser displacement sensor is disposed on the upper surface side or the lower surface side of the medium B1 to be conveyed. There is a step between the paper splice part Bic and the preceding sheet B1a or the succeeding sheet B1b. Consequently, in the medium B1, the distance from the laser displacement sensor to the preceding sheet B1a differs from the distance from the laser displacement sensor to the succeeding sheet B1b. The control device 64 detects the sheet step, by comparing the time at which a laser light transmitted from the laser displacement sensor toward the preceding sheet B1a returns after reflection, and the time at which a laser light transmitted from the laser displacement sensor toward the succeeding sheet B1b returns after reflection. The control device 64 then detects the paper splice part B1c on the basis of the location of the sheet step.

### <Single-Faced Web Splice Detection Unit>

FIG. 6 is a schematic diagram illustrating a single-faced web splice detection unit.

As illustrated in FIG. 6, the single-faced web D1 is formed by attaching the sheet-like top liner C1 to the corrugated medium B1. The single-faced web D1 is conveyed while being wound around a guide roll 184c, which will be described later, by a predetermined angle. In this process, the single-faced web D1 is guided such that the top liner C1 comes into contact with the guide roll 184c, and the corrugated medium B1 is disposed outside.

The single-faced web splice detection unit 62 includes the laser displacement sensor 62a. The laser displacement sensor 62a includes an irradiation unit 62a-1 and a light reception unit 62a-2. For example, the irradiation unit 62a-1 emits a laser beam of a certain width. The irradiation unit 62a-1 emits a laser beam in the tangential direction of the single-faced web D1 wound around the guide roll 184c. In this process, the irradiation unit 62a-1 emits a laser beam toward the corrugated medium B1 in the single-faced web D1. The light reception unit 62a-2 receives the laser beam emitted from the irradiation unit 62a-1. The light reception unit 62a-2 is disposed opposite to the irradiation destination of the laser beam emitted from the irradiation unit 62a-1. The light reception unit 62a-2 receives the laser beam that is emitted from the irradiation unit 62a-1, and is not blocked by the medium B1 in the single-faced web D1.

The single-faced web D1 is conveyed while being guided by the guide roll 184c. The irradiation unit 62a-1 emits a laser beam toward the medium B1 in the single-faced web D1 guided by the guide roll 184c. In this process, if the corrugation of the medium B1 in the single-faced web D1 is not crushed and deformed, the laser beam is blocked by the corrugations of the medium B1. Then, the light reception unit 62a-2 receives the laser beam the width of which is reduced by being blocked by the corrugation of the medium B1. On the other hand, if the corrugations of the medium B1 in the single-faced web D1 are crushed and deformed, the amount of laser beam blocked by the corrugation (corrugation deformed part) of the medium B1 will be reduced. Then, the light reception unit 62a-2 receives the laser beam that is not blocked by the corrugation of the medium B1 and the width of which is hardly reduced. The control device 64 detects the paper splice part and the corrugation deformed part on the basis of the width of the laser beam input from the laser displacement sensor 62a.

That is, the width of the laser beam at the single-faced web D1 in which normal corrugations are formed on the position other than the paper splice part is measured in advance. The determination value (determination area) is set on the basis of the width of the laser beam measured in this process. Then, the control device 64 detects the paper splice part and the corrugation deformed part, by comparing the width of the laser beam input from the laser displacement sensor 62a and the determination value. That is, if the width of the laser beam input from the laser displacement sensor 62a is within the range of determination value, the control device 64 determines that the single-faced web D1 is a non-defective product. Then, if the width of the laser beam input from the laser displacement sensor 62a exceeds the determination value, the control device 64 determines that the corrugations are deformed. That is to say, the control device 64 determines that the product is a defective product with a corrugation deformed part. On the other hand, if the width of the laser beam input from the laser displacement sensor 62a is equal to or less than the determination value, the control device 64 determines that the product is a defective product with a paper splice part. The width of the laser beam at the single-faced web D1 in which normal corrugations are formed on the position of the paper splice part may be measured in advance, to provide a determination value for the paper splice part.

The laser displacement sensor 62a that detects the paper splice part and the corrugation deformed part in the single-faced web D1 has been described. The same applies to the laser displacement sensor 62b that detects the paper splice part and the corrugation deformed part in the single-faced web D2.

### <Corrugation Deformation Device>

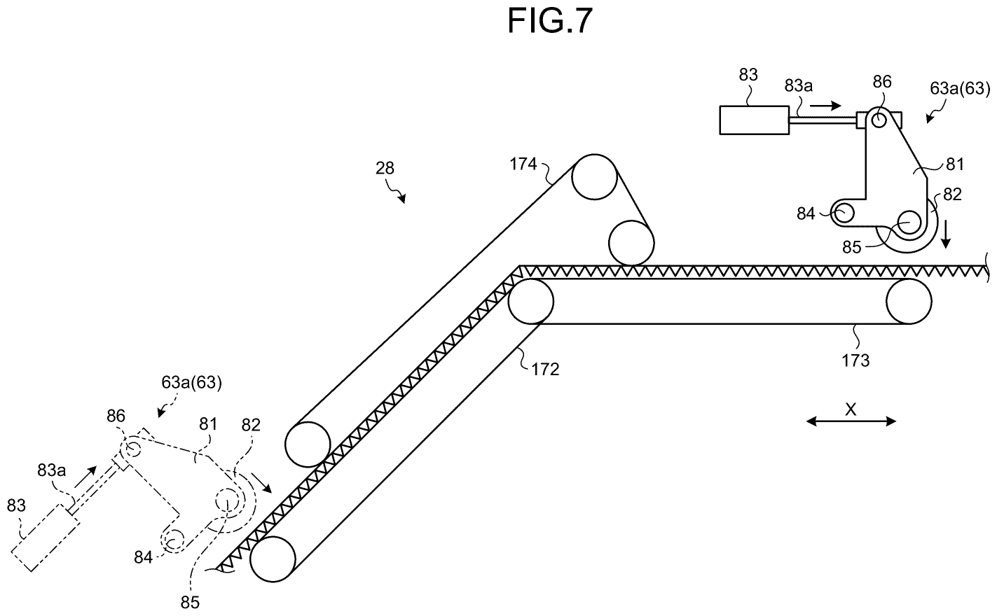

FIG. 7 is a schematic diagram illustrating the corrugation deformation device.

As illustrated by the solid lines in FIG. 7, the corrugation deformation device 63 is disposed on the downstream side of the take-up conveyor 28 in the sheet conveyance direction. The take-up conveyor 28 includes a first lower belt 172, a second lower belt 173, and an upper belt 174. The corrugation deformation device 63 forms a corrugation deformed part, by crushing and deforming the corrugated medium B1 in the single-faced web D1 that is conveyed by the belts 172, 173, and 174.

The corrugation deformation device 63 includes a crushing device 63a. The crushing device 63a includes a rotating link 81, a crushing roller 82, and a drive device 83. The rotating link 81 is rotatably supported on a frame (not illustrated) by a mounting member 84. The crushing roller 82 is rotatably supported by a support member 85 at the lower part of the rotating link 81. The drive device 83 is mounted on the frame (not illustrated), and the tip end part of a drive rod 83a is connected to the upper part of the rotating link 81 by a connecting member 86. The drive device 83 is a hydraulic pressure cylinder such as an air cylinder and a hydraulic cylinder. However, the drive device 83 may be a drive motor. The crushing roller 82 is disposed above a guide roll that supports the second lower belt 173 with a predetermined gap therebetween. The predetermined gap is a gap in which the single-faced web D1 supported by the guide roll can be conveyed without coming into contact with the crushing roller 82.

Consequently, the single-faced web D1 is conveyed by the take-up conveyor 28. The control device 64 activates the crushing device 63a at a predetermined timing. Upon being activated by the drive device 83, the crushing device 63a extends the drive rod 83a, and rotates the rotating link 81 in the clockwise direction in FIG. 7. Then, the crushing roller 82 moves to come into contact with the single-faced web D1 that is guided by the second lower belt 173, and forms a corrugation deformed part by crushing the corrugations of the medium B1 in the single-faced web D1. The laser displacement sensor 62a of the single-faced web splice detection unit 62 detects the corrugation deformed part formed by the crushing device 63a.

As illustrated by the two-dot chain lines in FIG. 7, the crushing device 63a may be disposed on the upstream side of the take-up conveyor 28 in the conveyance direction. The crushing roller 82 is disposed above the guide roll that supports the first lower belt 172 with a predetermined gap therebetween. The predetermined gap is a gap in which the single-faced web D1 supported by the guide roll can be conveyed without coming into contact with the crushing roller 82. The crushing device 63a forms a corrugation deformed part, by crushing and deforming the corrugated medium B1 in the single-faced web D1 that is conveyed by the belts 172, 173, and 174.

Moreover, although the crushing roller 82 is provided as the crushing device 63a, the crushing roller 82 may be a drivable roller or a rotating roller capable of rotating therewith. Furthermore, the crushing device 63a is not limited to the crushing roller 82, and may be a crushing block, a crushing plate, and the like, and the shape thereof is not limited. The crushing roller 82 is rotatably supported by the rotating link 81. However, the crushing roller 82 may be slidable.

The crushing device 63a of the single-faced web D1 has been described. The same applies to the crushing device 63b of the single-faced web D2.

### <Single Facer>

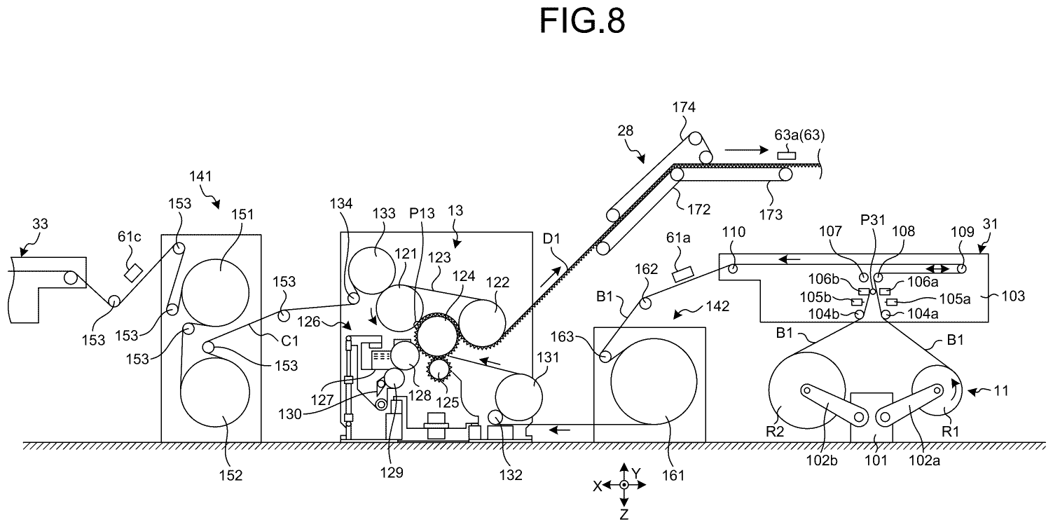

FIG. 8 is a schematic diagram of the periphery of the single facer used for explaining a flow of the medium, the top liner, and the single-faced web. Because the single facer 13 and the single facer 17 have substantially the same configuration, the configuration of the periphery of the single facer 13 will be described, and the configuration of the periphery of the single facer 17 will be omitted.

As illustrated in FIG. 8, in the mill roll stand 11, a stand 101 is installed on a predetermined position, and roll support arms 102a and 102b are provided on both sides of the stand 101 in the X direction. The tip end parts of the roll support arms 102a and 102b rotatably support rolls of paper R1 and R2 of the medium B1. Each of the rolls of paper R1 and R2 is the medium B1 of a predetermined length rolled into a roll. For example, in the mill roll stand 11, the medium B1 is supplied when the roll of paper R1 supported by the one roll support arm 102a is rotated, and the roll of paper R2 supported by the other roll support arm 102b is stopped to stand by for splicing of the medium B1.

The splicer 31 is disposed above the mill roll stand 11 in the Z direction. In the splicer 31, a pair of introduction rolls 104a and 104b, a pair of knives 105a and 105b, and a pair of crimping bars 106a and 106b are disposed toward the upper side of a header 103 in the Z direction. In the splicer 31, a nip roll 107 and an acceleration roll 108 are disposed facing each other, above the crimping bars 106a and 106b in the Z direction. The pair of introduction rolls 104a and 104b, the pair of knives 105a and 105b, and the pair of crimping bars 106a and 106b are provided in an approachable and separable manner for each pair along the X direction. The nip roll 107 is provided in an approachable and separable manner along the X direction with respect to the acceleration roll 108. In the header 103, a dancer roll 109 and a fixing roll 110 are disposed above the nip roll 107 and the acceleration roll 108 in the Z direction. Although not illustrated, a plurality of the dancer rolls 109 are provided (for example, three rolls). According to the tension of the medium B1, the dancer roll 109 can move freely along the horizontal direction. That is, the dancer roll 109 can move freely between the position illustrated in FIG. 8 and the position approaching the fixing roll 110.

Consequently, when the medium B1 is reeled out from the roll of paper R1, the medium B1 is conveyed between the introduction rolls 104a and 104b, between the knives 105a and 105b, and between the crimping bars 106a and 106b, and via the acceleration roll 108, the dancer roll 109, and the fixing roll 110. When splicing is performed by the splicer 31, the medium B1 is stopped from being reeled out from the roll of paper R1. Then, the splicing is performed by attaching the medium B1 from the roll of paper R2 that is standing by, to the medium B1 of the roll of paper R1. Then, the medium B1 is reeled out by rotating the roll of paper R2.

That is, the medium B1 is reeled out from the roll of paper R2 and attached to the crimping bar 106b. By reducing the reeling speed of the medium B1 from the roll of paper R1, and moving the dancer roll 109 to the fixing roll 110 side, the consumption of the retained medium B1 will be started. In this example, by stopping the medium B1 from being reeled out from the roll of paper R1, and bringing the crimping bars 106a and 106b close to each other, the medium B1 from the roll of paper R2 is pressed to the medium B1 from the roll of paper R1, and is pressure bonded with adhesive (double-sided tape). At the same time as this operation, the knife 105a moves forward to cut the medium B1 from the roll of paper R1.

During the splicing, the dancer roll 109 moves to keep the tension of the medium B1 constant, while the retained medium B1 is continuously supplied. When the medium B1 is cut from the roll of paper R1, and when the medium B1 is reeled out from the roll of paper R2, the nip roll 107 comes into contact with the acceleration roll 108. By increasing the rotation speed of the acceleration roll 108, the supply of the retained core B1 will be finished. Then, the dancer roll 109 starts moving to return to the original position.

The mill roll stand 12 (see FIG. 1) that reels out the top liner C1, and the splicer 33 that splices the top liner C1, are almost the same as the mill roll stand 11 and the splicer 31.

The single facer 13 includes a belt roll 121, a tension roll 122, a pressure belt 123, an upper roll 124, a lower roll 125, and a gluing device 126.

The belt roll 121 can be driven and rotated by a drive device, which is not illustrated. The tension roll 122 is rotatably supported by the belt roll 121 with a predetermined gap therebetween. The pressure belt 123 is an endless belt, and is wound around the belt roll 121 and the tension roll 122. The upper roll 124 can be driven and rotated by a drive device, which is not illustrated, and the outer peripheral surface of which is formed into a corrugated shape. The upper roll 124 is disposed below the pressure belt 123 in the Z direction between the belt roll 121 and the tension roll 122, and the corrugated outer peripheral surface of the upper roll 124 abuts the lower surface of the pressure belt 123 in a pressurized state. Similar to the upper roll 124, the outer peripheral surface of the lower roll 125 is formed into a corrugated shape, and is meshed with the outer peripheral surface of the upper roll 124 below the upper roll 124 in the Z direction. The belt roll 121, the tension roll 122, the upper roll 124, and the lower roll 125 are heated when steam is circulated therethrough. The medium B1 and the top liner C are heated via the pressure belt 123 and the upper roll 124.

The gluing device 126 is disposed in the vicinity of the upper roll 124 in the X direction. The gluing device 126 includes a glue dam 127, a gluing roll 128, a meter roll 129, and a glue scraping blade 130. The glue dam 127 stores therein a predetermined amount of glue. The gluing roll 128 applies the glue stored in the glue dam 127 to the medium B1 conveyed by the upper roll 124 for gluing. The meter roll 129 adjusts the amount of glue to be applied to the outer peripheral surface of the gluing roll 128, while coming into contact with the outer peripheral surface of the gluing roll 128 and by rotating synchronously. The glue scraping blade 130 scrapes off the excess glue adhering to the outer peripheral surface of the meter roll 129 that is removed from the gluing roll 128, by coming into contact with the outer peripheral surface of the meter roll 129.

The single facer 13 includes a preheating roll 131 and an angle adjustment roll 132 that introduce the medium B1, which is supplied from the splicer 31, between the upper roll 124 and the lower roll 125. The angle adjustment roll 132 adjusts the contact position where the medium B1 comes into contact with the outer peripheral surface of the preheating roll 131, while moving around the preheating roll 131. Moreover, the single facer 13 includes a preheating roll 133 and a fixing roll 134 that introduce the top liner C1, which is supplied from the splicer 33, between the pressure belt 123 and the upper roll 124.

The single facer 13 includes preheaters 141 and 142. The preheater 141 preheats the top liner C1. The preheater 141 is disposed adjacent to the preheating roll 133. The preheater 141 includes two preheating rolls 151 and 152 arranged side by side in the Z direction. The preheating rolls 151 and 152 heat the top liner C1, when the top liner C1 is wound therearound. The preheating rolls 151 and 152 each include a winding amount adjustment device (not illustrated), and are heated to a predetermined temperature when steam is supplied to the inside thereof. A plurality of guide rolls 153 are provided on the upstream side and the downstream side of the preheating rolls 151 and 152.

The preheater 142 preheats the medium B1. The preheater 142 is disposed adjacent to the preheating roll 131. The preheater 142 includes one preheating roll 161 and an angle adjustment roll 163. The preheating roll 161 heats the medium B1 when the medium B1 is wound therearound. The angle adjustment roll 163 adjusts the contact position where the medium B1 comes into contact with the outer peripheral surface of the preheating roll 161, while moving around the preheating roll 161. The preheating roll 161 is heated to a predetermined temperature when steam is supplied to the inside thereof. A guide roll 162 is provided on the upstream side of the preheating roll 161.

Moreover, the single facer 13 includes the take-up conveyor 28 at the exit part of the single-faced web D1. The take-up conveyor 28 guides the single-faced web D1 formed by the single facer 13, and supplies the single-faced web D1 to the bridge 14 (see FIG. 1). The take-up conveyor 28 includes the first lower belt 172, the second lower belt 173, and the upper belt 174. The first lower belt 172 and the upper belt 174 are disposed diagonally upward, while the second lower belt 173 is disposed along the horizontal direction. The first lower belt 172, the second lower belt 173, and the upper belt 174 can be driven by a drive device, which is not illustrated. The single-faced web D1 is conveyed while being interposed between the first lower belt 172 and second lower belt 173, and the upper belt 174.

The top liner C1 is supplied from the splicer 33 to the single facer 13 via the preheater 141. After being wounded around the preheating roll 133, the top liner C1 is transferred to a nip part between the pressure belt 123 and the upper roll 124, with the pressure belt 123 guided by the belt roll 121. On the other hand, the medium B1 is supplied from the splicer 31 to the single facer 13 via the preheater 142. After being wound around the preheating roll 131, the medium B1 is processed into a corrugated shape at a meshing part between the upper roll 124 and the lower roll 125, and is transferred to a nip part between a pressure belt 113 and an upper roll 114 while being guided by the upper roll 124.

After being processed into a corrugated shape at the meshing part between the upper roll 124 and the lower roll 125, glue is applied to the medium B1 by the gluing device 126. The glue stored in the glue dam 127 adheres to the rotating gluing roll 128, and the adhesion amount of glue on the outer peripheral surface is adjusted by the meter roll 129. Glue is applied to the corrugation tops of the medium B1 that is processed into a corrugated shape at the meshing part between the upper roll 124 and the lower roll 125, by coming into contact with the gluing roll 128. Upon being transferred to the nip part between the pressure belt 123 and the upper roll 124, the glued medium B1 is attached to the top liner C1 to form the single-faced web D1.

The single facer 13 includes the ultrasonic sensor 61a that detects the paper splice part of the medium B1 and the ultrasonic sensor 61c that detects the paper splice part of the top liner C1, as the sheet splice detection unit 61. The ultrasonic sensor 61a is disposed between the fixing roll 110 of the splicer 31 and the guide roll 162 of the preheater 142. The ultrasonic sensor 61a detects the paper splice part of the medium B1 that is conveyed between the fixing roll 110 of the splicer 31 and the guide roll 162 of the preheater 142. The location of the ultrasonic sensor 61a is not limited thereto. The ultrasonic sensor 61a may be disposed anywhere between the dancer roll 109 of the splicer 31 and the preheating roll 131 of the single facer 13. In this case, the dancer roll 109 sends out the retained medium B1 while moving during splicing. Hence, it is preferable to dispose the ultrasonic sensor 61a in the downstream of the maximum moving position of the dancer roll 109.

The ultrasonic sensor 61c is disposed between the guide rolls 153 of the preheater 141. The ultrasonic sensor 61c detects the paper splice part of the top liner C1 to be conveyed between the guide rolls 153 of the preheater 141. The location of the ultrasonic sensor 61c is not limited thereto. The ultrasonic sensor 61c may be disposed anywhere between the dancer roll 109 of the splicer 33 and the preheating roll 133 of the single facer 13. In this case, the dancer roll 109 sends out the retained top liner C1 while moving during splicing. Hence, it is preferable to dispose the ultrasonic sensor 61c in the downstream of the maximum moving position of the dancer roll 109.

The single facer 13 includes the crushing device 63a that forms a corrugation deformed part in the single-faced web D1, as the corrugation deformation device 63. The crushing device 63a is disposed on the downstream side of the take-up conveyor 28 between the single facer 13 and the bridge 14. The crushing device 63a forms the corrugation deformed part, by crushing and deforming the medium B1 of the single-faced web D1 that is formed by attaching the medium B1 processed into a corrugated shape by the single facer 13 to the top liner C1.

The locations of the ultrasonic sensors 61a and 61c serving as the sheet splice detection unit 61, and the crushing device 63a serving as the corrugation deformation device 63 disposed on the periphery of the single facer 13 have been described. Although not illustrated, the same applies to the locations of the ultrasonic sensors 61b and 61d serving as the sheet splice detection unit 61, and the crushing device 63b serving as the corrugation deformation device 63, disposed on the periphery of the single facer 17.

### <Double Facer>

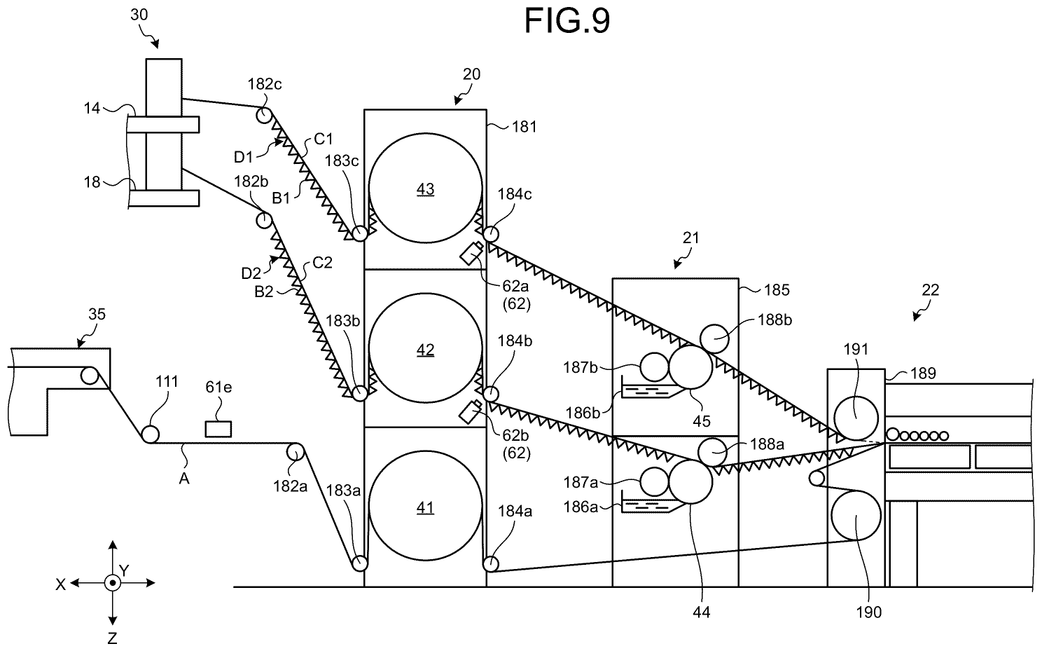

FIG. 9 is a schematic diagram of the periphery of a double facer used for explaining a flow of the bottom liner and the single-faced web.

As illustrated in FIG. 9, the paper guide device 30 is provided at the exit part of each of the bridge 14 and the bridge 18. The paper guide device 30 includes a twisting roller, which is not illustrated, and the twisting roller comes into contact with the upper surfaces of the single-faced web D1 and the single-faced web D2, that is, the top liner C1 and the top liner C2. While the twisting roller is brought into contact with the single-faced web, a moving device, which is not illustrated, moves one of the end parts of the twisting roller in the X direction. Then, the twisting roller tilts in the X direction, and the single-faced web D1 and the single-faced web D2 are guided to the twisting roller. Accordingly, the positions of the single-faced web D1 and the single-faced web D2 in the Y direction are adjusted. Hence, it is possible to restrain the single-faced web D1 and the single-faced web D2 from being conveyed in a meandering manner or in a shifting manner.

In the preheater 20, the preheating rolls 41, 42, and 43 are rotatably supported by a frame 181. The preheating rolls 41, 42, and 43 heat the bottom liner A, the single-faced web D2, and the single-faced web D1. On the preheating rolls 41, 42, and 43, guide rolls 182a, 182b, and 182c, and winding angle adjustment rolls 183a, 183b, and 183c are each disposed on the upstream side in the conveyance direction, and guide rolls 184a, 184b, and the guide roll 184c are each disposed on the downstream side. The winding angle adjustment rolls 183a, 183b, and 183c move in the peripheral direction of the preheating rolls 41, 42, and 43, to adjust the winding angles of the bottom liner A, the single-faced web D2, and the single-faced web D1, and to adjust the preheating temperature.

In the glue machine 21, the gluing rolls 44 and 45 are rotatably supported by a frame 185. Each of the gluing rolls 44 and 45 applies the glue from glue dams 186a and 186b to each of the mediums B2 and B1, in the single-faced web D2 and the single-faced web D1. Meter rolls 187a and 187b that adjust the adhesion amount of glue are disposed so as to come into contact with the gluing rolls 44 and 45, and rider rolls 188a and 188b are disposed so as to face the gluing rolls 44 and 45. In the double facer 22, preheaters 190 and 191 are rotatably supported by a frame 189. The bottom liner A is guided to the double facer 22 via the preheater 190, and the single-faced webs D1 and D2 are guided to the double facer 22 via the preheater 191.

The ultrasonic sensor 61e that detects the paper splice part of the bottom liner A is provided as the sheet splice detection unit 61. The ultrasonic sensor 61e is disposed between a fixing roll 111 of the splicer 35 and the guide roll 182a of the preheater 20. The ultrasonic sensor 61e detects the paper splice part of the bottom liner A that is conveyed between the fixing roll 111 of the splicer 35 and the guide roll 182a of the preheater 20. The location of the ultrasonic sensor 61e is not limited thereto. The ultrasonic sensor 61e may be disposed anywhere between the dancer roll 109 of the splicer 35 and the preheater 190 of the double facer 22. In this case, the dancer roll 109 sends out the retained bottom liner A while moving during splicing. Hence, it is preferable to dispose the ultrasonic sensor 61e in the downstream of the maximum moving position of the dancer roll 109.

As the single-faced web splice detection unit 62, the laser displacement sensors 62a and 62b that detect the paper splice parts and the corrugation deformed parts in the single-faced webs D1 and D2 are provided, respectively. The laser displacement sensors 62a and 62b are disposed between the paper guide device 30 and the gluing rolls 44 and 45 of the glue machine 21. More specifically, the laser displacement sensors 62a and 62b are disposed between the preheating rolls 42 and 43 of the preheater 20, and the gluing rolls 44 and 45 of the glue machine 21. The laser displacement sensors 62a and 62b measure the thicknesses of the single-faced webs D1 and D2 that are conveyed between the paper guide device 30 and the gluing rolls 44 and 45 of the glue machine 21. More specifically, the laser displacement sensors 62a and 62b detect the paper splice part and the corrugation deformed part on the basis of the thicknesses of the single-faced webs D1 and D2 that are conveyed between the preheating rolls 43 and 42 of the preheater 20, and the gluing rolls 45 and 44 of the glue machine 21.

Moreover, for example, the laser displacement sensors 62a and 62b are disposed on positions facing the guide rolls 184c and 184b, respectively. By being brought into contact with the guide rolls 184c and 184b, the single-faced web D1 and the single-faced web D2 are prevented from swaying during conveyance. Hence, the laser displacement sensors 62a and 62b can detect the paper splice part and the corrugation deformed part with high accuracy. The locations of the laser displacement sensors 62a and 62b are not limited thereto. The laser displacement sensors 62a and 62b may be disposed anywhere between the bridges 14 and 18 and the double facer 22.

### <Specific Configuration of Control Device>

The configuration of the control device will be described. As illustrated in FIG. 2, the control device 64 includes a paper splicing time setting unit 71, a determination unit 72, and a single-faced web length-on-bridge calculation unit 73.

The paper splicing time setting unit 71 sets the paper splicing times of the bottom liner A, the mediums B1 and B2, and the top liners C1 and C2 in the splicers 31, 32, 33, 34, and 35. In particular, when the lots are changed, the paper splicing time setting unit 71 sets the paper splicing times of the mediums B1 and B2 and the top liners C1 and C2 in the splicer 31 and splicer 33, and the splicer 32 and splicer 34. At the attachment positions of the corrugated mediums B1 and B2 and the top liners C1 and C2, the paper splicing time setting unit 71 sets at least one of the paper splicing times of the splicers 31 and 32, and the splicers 33 and 34, such that the paper splice parts of the top liners C1 and C2 are placed on the downstream side of the paper splice parts of the mediums B1 and B2 in the sheet conveyance direction.

That is, at the attachment positions of the corrugated mediums B1 and B2 and the top liners C1 and C2, the paper splicing time setting unit 71 sets the paper splicing times of the splicers 31 and 32 and the splicers 33 and 34 such that the paper splice parts of the top liners C1 and C2 precedes the paper splice parts of the mediums B1 and B2 by a predetermined distance set in advance. In this case, the paper splicing time setting unit 71 sets at least one of the paper splicing times of the splicers 31 and 32 and the splicers 33 and 34, on the basis of a second distance from the sheet splicing positions of the mediums B1 and B2 in the splicers 31 and 32 to the sheet attachment positions in the single facers 13 and 17, a third distance from the sheet splicing positions of the top liners C1 and C2 in the splicers 33 and 34 to the sheet attachment positions in the single facers 13 and 17, the conveyance speeds of the mediums B1 and B2 and the top liners C1 and C2, and the corrugation ratio of the mediums B1 and B2.

A method for setting the paper splicing times of the splicer 31 that splices the medium B1 and the splicer 33 that splices the top liner C1 will be described. The same applies to a method for setting the paper splicing times of the splicer 32 that splices the medium B2 and the splicer 34 that splices the top liner C2.

With reference to FIG. 8, various reference numerals will be described. A second distance L2 is the distance from a sheet splicing position P31 of the medium B1 in the splicer 31 to a sheet attachment position P13 in the single facer 13. A third distance L3 is the distance from a sheet splicing position P33 (not illustrated) of the top liner C1 in the splicer 33 to the sheet attachment position P13 in the single facer 13. Conveyance speed V is the conveyance speed of the mediums B1 and B2 and the top liners C1 and C2, and is the same speed. A corrugation ratio R is the ratio of the length of the medium B1 before and after being corrugated.

In the corrugating machine of the present embodiment, from the positional relation of the splicer 31, the single facer 13, and the splicer 33, the third distance L3 is longer than the second distance L2, and a relation of second distance L2<third distance L3 holds. The following equation represents time TB that is the time it takes the paper splice part of the medium B1 to reach the sheet attachment position P13 in the single facer 13 from the sheet splicing position P31 in the splicer 31.

$$TB = L 2 / VR$$

On the other hand, the following equation represents time TC that is the time it takes the paper splice part of the top liner C1 to reach the sheet attachment position P13 in the single facer 13 from the sheet splicing position P33 in the splicer 33.

$$TC = L 3 / V$$

In this example, because it is second distance L2<third distance L3, the time will be TB(L2/VR)<TC(L3/V). That is to say, when the mediums B1 and B2 and the top liners C1 and C2 are spliced at the same time by the splicers 31 and 33, the paper splice part of the medium B1 precedes the paper splice part of the top liner C12 by a time difference ΔT(TC−TB)n, at the sheet attachment position P13. Therefore, under the conditions described above, it is necessary to set the paper splicing time to cause the paper splice part of the top liner C12 to precede the paper splice part of the medium B1 by a predetermined distance N at the sheet attachment position P13.

That is, at the sheet attachment position P13, it is necessary to delay the paper splicing time of the medium B1 relative to the paper splicing time of the top liner C1, by the total time Tm (ΔT+Tn) of the time difference ΔT and the time Tn (N/V) corresponding to the predetermined distance N. In this case, time TB1 that is the time it takes the paper splice part of the medium B1 to reach the sheet attachment position P13 in the single facer 13 becomes TB+Tm (ΔT+Tn). Hence, the following equation represents the conditions to be TB1>TC.

$$L 2 / V \times R + ( L 3 / V - L 2 / VR ) + N / V > L 3 / V$$

To satisfy this formula, the control device 64 activates the splicers 31 and 33 at the set splicing time. The control device 64 activates each of the splicers 31 and 33, at the sheet splicing time of the medium B1 by the splicer 31 and the paper splicing time of the top liner C1 by the splicer 33 set by the paper splicing time setting unit 71. Then, at the sheet attachment position P13 in the single facer 13, the paper splice part of the top liner C1 precedes the paper splice part of the medium B1 by the predetermined distance N. In this example, the predetermined distance N is the distance at which an adhesion failure of the paper splice part of the top liner C1 and the paper splice part of the medium B1 hardly occurs, and is the distance at which the defective length of the single-faced web D1 will not be unnecessarily long. The predetermined distance N is preferably shorter than the plate-shaped single-wall corrugated cardboard F cut by the cutoff 25, and, for example, is the length within the range of 100 mm to 600 mm.

In the above description, as the paper splicing time to cause the paper splice part of the top liner C12 to precede the paper splice part of the medium B1 by the predetermined distance N at the sheet attachment position P13, the paper splicing time of the medium B1 is delayed with respect to the paper splicing time of the top liner C1. That is to say, the control device 64 has controlled to delay the paper splicing time of the medium B1 by the splicer 33, while maintaining the paper splicing time of the top liner C1 by the splicer 33 as it is. In this case, the control device 64 may control at least one of the paper splicing time of the top liner C1 by the splicer 33 and the paper splicing time of the medium B1 by the splicer 33.

Moreover, in the above description, the positional relation of the splicer 31, the single facer 13, and the splicer 33 is described as second distance L2<third distance L3. However, even if the positional relation of the splicer 31, the single facer 13, and the splicer 33 is second distance L2>third distance L3 or second distance L2=third distance L3, it is possible to set the paper splicing time of the medium B1 and the paper splicing time of the top liner C1 with the same method.

Returning to FIG. 2, the paper splicing time setting unit 71 also sets the paper splicing time of the bottom liner A on the basis of the length of the single-faced web D1. When the lots are changed, the types of the bottom liner A, the medium B1, and the top liner C1 are changed. In this process, the paper splicing time setting unit 71 sets the paper splicing time of the bottom liner A, on the basis of the length of the single-faced web D1 calculated by the single-faced web length-on-bridge calculation unit 73, which will be described later. That is, the paper splicing time setting unit 71 sets the paper splicing time of the bottom liner A such that the paper splice part of the bottom liner A substantially matches with each paper splice part of the single-faced web D1 in the sheet conveyance direction.

The determination unit 72 determines whether the paper splice part of the top liner C1 precedes the paper splice part of the medium B1 at the sheet attachment position P13 in the single facer 13. The ultrasonic sensor 61a is disposed between the splicer 31 and the single facer 13, and the ultrasonic sensor 61c is disposed between the splicer 33 and the single facer 13. The ultrasonic sensors 61a and 61c output the detection results to the control device 64. The ultrasonic sensor 61a detects the paper splice part of the medium B1, and the ultrasonic sensor 61c detects the paper splice part of the top liner C1. The determination unit 72 determines which of the paper splice part of the medium B1 and the paper splice part of the top liner C1 precedes, by comparing the detection time of the paper splice part of the medium B1 by the ultrasonic sensor 61a and the detection time of the paper splice part of the top liner C1 by the ultrasonic sensor 61c.

The single-faced web length-on-bridge calculation unit 73 calculates the length of the single-faced web D1 that is retained at the bridge 14, on the basis of the detection results of the sheet splice detection unit 61 and the single-faced web splice detection unit 62. Specifically, the single-faced web length-on-bridge calculation unit 73 calculates the length, on the basis of the detection result of the paper splice part of the top liner C1 by the ultrasonic sensor 61c and the detection result of the paper splice part of the top liner C1 by the laser displacement sensor 62a. The single-faced web length-on-bridge calculation unit 73 calculates the length of the single-faced web D1 from the sheet splice detection unit 61 to the single-faced web splice detection unit 62, on the basis of the time when the ultrasonic sensor 61c has detected the paper splice part of the top liner C1, the time when the laser displacement sensor 62a has detected the paper splice part of the top liner C1, and the conveyance speed of the single-faced web D1.

When the determination unit 72 determines that the paper splice part of the top liner C1 precedes the paper splice part of the medium B1 at the sheet attachment position P13 in the single facer 13, the single-faced web length-on-bridge calculation unit 73 calculates the length on bridge on the basis of the detection results of the sheet splice detection unit 61 and the single-faced web splice detection unit 62. On the other hand, when the determination unit 72 determines that the paper splice part of the top liner C1 does not precede the paper splice part of the medium B1 at the sheet attachment position P13 in the single facer 13, the single-faced web length-on-bridge calculation unit 73 does not calculate the length on bridge on the basis of the detection results of the sheet splice detection unit 61 and the single-faced web splice detection unit 62.

Moreover, the single-faced web length-on-bridge calculation unit 73 can calculate the length on bridge of the single-faced web D1 that is retained at the bridge 14, on the basis of the operation timing of the corrugation deformation device 63 (crushing device 63a) and the detection timing of the single-faced web splice detection unit 62. That is, the single-faced web length-on-bridge calculation unit 73 calculates the length on bridge of the single-faced web D1 from the corrugation deformation device 63 to the single-faced web splice detection unit 62, on the basis of the time when the corrugation deformation device 63 has deformed the corrugations of the medium B1, the time when the laser displacement sensor 62a has detected the corrugation deformed part of the medium B1, and the conveyance speed of the single-faced web D1.

The processes performed on the medium B1, the top liner C1, and the single-faced web D1 by the paper splicing time setting unit 71, the determination unit 72, and the single-faced web length-on-bridge calculation unit 73 have been described. The same applies to the processes performed on the medium B2, the top liner C2, and the single-faced web D2.

Moreover, the control device 64 controls the operation timing of the waste removing device 26 on the basis of the position information on the paper splice part detected by the sheet splice detection unit 61 and the position information of the corrugation deformed part detected by the single-faced web splice detection unit 62. By activating the waste removing device 26 at a predetermined timing, the control device 64 removes the single-wall corrugated cardboard F to be a defective product with the paper splice part and the corrugation deformed part, from the conveyance line.

### <Shape of Single-Faced Web>

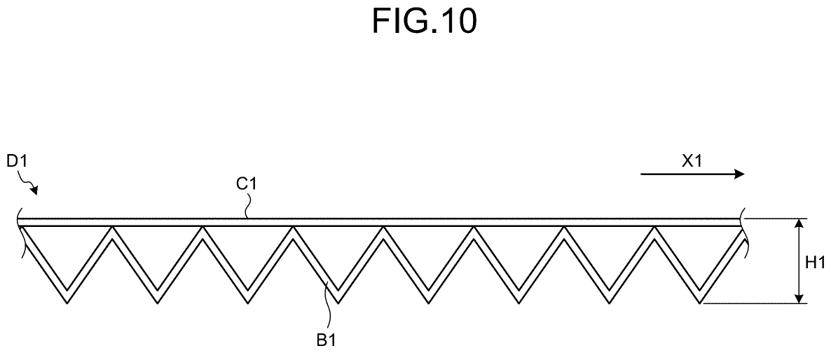

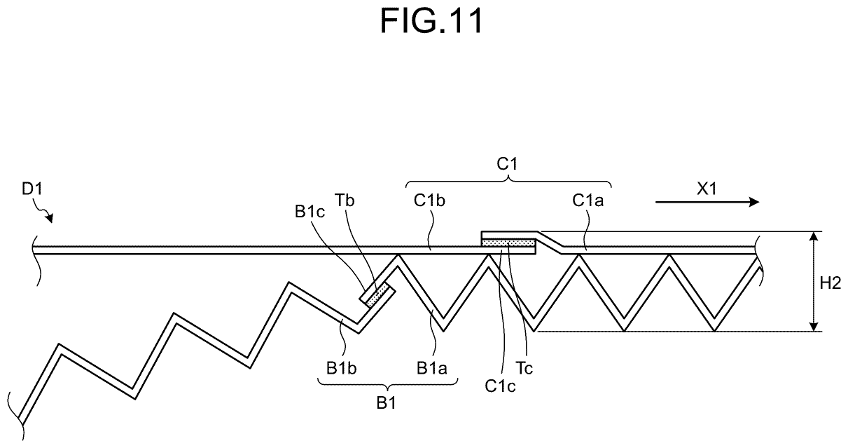

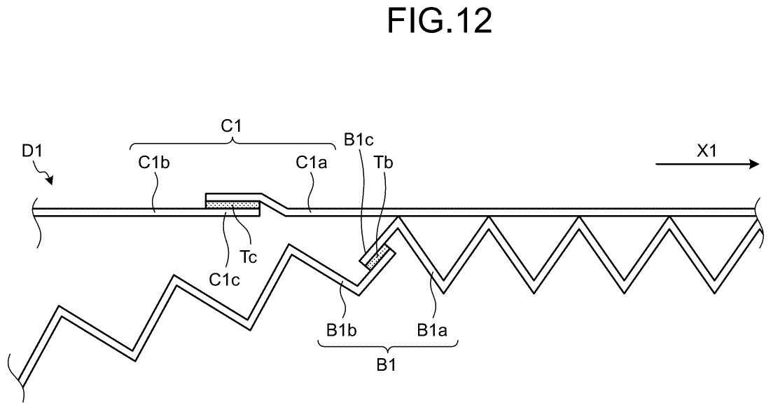

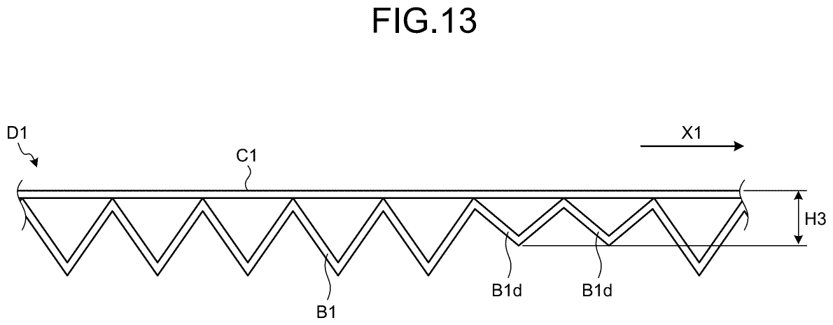

FIG. 10 is a schematic diagram illustrating the single-faced web. FIG. 11 is a schematic diagram illustrating a paper splice part of the single-faced web. FIG. 12 is a schematic diagram illustrating a defect in the paper splice part of the single-faced web. FIG. 13 is a schematic diagram illustrating a corrugation deformed part in the single-faced web.

For example, as illustrated in FIG. 10, the single-faced web D1 is formed by attaching the sheet-like top liner C1 to the corrugated medium B1. The single-faced web D1 has a normal thickness H1, if there is no paper splice part in the medium B1 and the top liner C1, and if the corrugations of the medium B1 have a proper shape. Since the thickness of the single-faced web D1 varies due to manufacturing errors, it is preferable to set the normal thickness H1 to a normal thickness range of H1a to H1b. The same applies to the single-faced web D2.

As illustrated in FIG. 11, as described above, at the attachment position of the medium B1 and the top liner C1, splicing is performed such that a paper splice part C1c of the top liner C1 is placed on the downstream side of the paper splice part B1c of the medium B1 in the sheet conveyance direction X1. In this process, at the paper splice part B1c of the medium B1, the shape of corrugations becomes improper. Hence, an adhesion failure of the medium B1 and the top liner C1 tends to occur from the position of the paper splice part B1c of the medium B1 along a predetermined length. However, in the single-faced web D1, the paper splice part C1c of the top liner C1 precedes. Hence, even if there is an adhesion failure in the paper splice part B1c of the medium B1, it is possible to measure the thickness at a position where there is the paper splice part C1c of the top liner C1. In this process, the single-faced web D1 becomes thicker than the normal thickness H1, by a thickness obtained by adding the thickness of one sheet of the top liner C1 and the thickness of the double-sided tape Tc. Hence, the thickness will be thickness H2 (H1<H2). The control device 64 (see FIG. 3) detects the paper splice part C1c of the top liner C1 in the single-faced web D1, on the basis of the determination result of H1<H2.

On the other hand, as illustrated in FIG. 12, at the attachment position of the medium B1 and the top liner C1, on contrary to that illustrated in FIG. 11, when splicing is performed such that the paper splice part B1c of the medium B1 is placed on the upstream side of the paper splice part C1c of the top liner C1 in the sheet conveyance direction X1, the paper splice part B1c of the medium B1 precedes the paper splice part C1c of the top liner C1 in the single-faced web D1. In this process, at the paper splice part B1c of the medium B1, the shape of corrugations becomes improper. Hence, an adhesion failure of the medium B1 and the top liner C1 tends to occur from the position of the paper splice part B1c of the medium B1 along a predetermined length. In this case, it is not possible to measure the thickness of the single-faced web D1 at a position where the paper splice part C1c of the top liner C1 is present.

Moreover, as illustrated in FIG. 13, the single-faced web D1 is formed by attaching the sheet-liked top liner C1 to the corrugated medium B1. The corrugations of the medium B1 are crushed to form a corrugation deformed part B1d. The corrugation deformed part B1d is formed due to intentional factors of activating the corrugation deformation device 63 and natural factors caused by an operation error of the single facer 13 and the like. In this process, because the corrugation deformed part B1d is in the medium B1, the thickness of the single-faced web D1 becomes thinner than the normal thickness H1. Hence, the thickness will be thickness H3 (H3<H1). The control device 64 (see FIG. 3) detects the corrugation deformed part B1d of the medium B1 in the single-faced web D1, on the basis of the determination result of H3<H1.

The case of the single-faced web D1 has been described. The same applies to the single-faced web D2.

### <Operation of Device for Manufacturing Corrugated Cardboard>

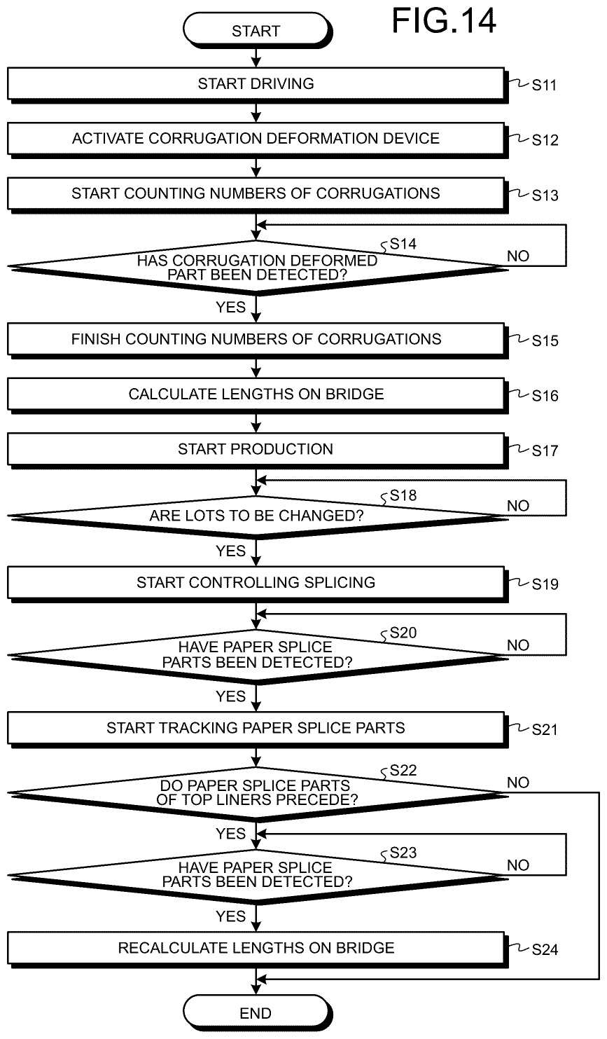

FIG. 14 is a flowchart illustrating the method for manufacturing a corrugated cardboard.

The method for manufacturing a corrugated cardboard includes a step of splicing a succeeding sheet to a preceding sheet in the mediums B1 and B2; a step of splicing a succeeding sheet to a preceding sheet in the top liners C1 and C2; a step of controlling at least one of the paper splicing times of the mediums B1 and B2 and the top liners C1 and C2 such that a paper splice part of the top liners C1 and C2 is placed on the downstream side of a paper splice part of the mediums B1 and B2 in the sheet conveyance direction X1, at the attachment positions of the mediums B1 and B2 and the top liners C1 and C2; and a step of detecting the paper splice parts of the top liners C1 and C2 on the basis of the thicknesses of the single-faced webs D1 and D2 in which the mediums B1 and B2 and the top liners C1 and C2 are attached to one another.

As illustrated in FIG. 3 and FIG. 14, at step S11, the control device 64 starts driving the corrugating machine 10. In this process, the corrugating machine 10 is loaded with the bottom liner A, the mediums B1 and B2, and the top liners C1 and C2 of a predetermined type. At step S12, the control device 64 activates the corrugation deformation device 63, and at step S13, the control device 64 starts counting the numbers of corrugations of the mediums B1 and B2, after the corrugation deformation device 63 is activated.

At step S14, the control device 64 determines whether the single-faced web splice detection unit 62 has detected a corrugation deformed part. In this process, if it is determined that the single-faced web splice detection unit 62 has not detected the corrugation deformed part (No), the control device 64 stands by as it is. On the other hand, if it is determined that the single-faced web splice detection unit 62 has detected the corrugation deformed part (Yes), at step S15, the control device 64 finishes counting the numbers of corrugations of the mediums B1 and B2, and at step S16, the control device 64 calculates the lengths on bridge on the basis of the counted numbers of corrugations of the mediums B1 and B2, the conveyance speed, and the corrugation ratio. Then, at step S17, the control device 64 starts producing corrugated cardboard sheets.

At step S18, the control device 64 determines whether to change the lots. For example, the control device 64 determines whether to change the lots, according to the presence of a lot change signal input from a production control device, which is not illustrated. In this process, if it is determined that the lots will not be changed (No), the control device 64 continues to produce the corrugated cardboard sheets. On the other hand, if it is determined that the lots will be changed (Yes), at step S19, the control device 64 starts controlling the splicing to change the types of the bottom liner A, the mediums B1 and B2, and the top liners C1 and C2.

That is, the control device 64 controls the paper splicing times of the bottom liner A, the mediums B1 and B2, and the top liners C1 and C2, by the splicers 31, 32, 33, 34, and 35. Specifically, at the attachment positions of the corrugated mediums B1 and B2 and the top liners C1 and C2, the control device 64 controls at least one of the paper splicing times of the splicers 31 and 32 and the splicers 33 and 34 such that the paper splice parts of the top liners C1 and C2 are placed on the downstream side of the paper splice parts of the mediums B1 and B2 in the sheet conveyance direction. Moreover, the control device 64 controls the paper splicing time of the bottom liner A on the basis of the lengths on bridge of the single-faced webs D1 and D2.

At step S20, the control device 64 determines whether the sheet splice detection unit 61 has detected the paper splice parts of the mediums B1 and B2 and the paper splice part of the top liners C1 and C2. In this process, if it is determined that the sheet splice detection unit 61 has not detected all the paper splice parts of the mediums B1 and B2 and the top liners C1 and C2 (No), the control device 64 stands by as it is. On the other hand, if it is determined that the sheet splice detection unit 61 has detected all the paper splice parts of the mediums B1 and B2 and the top liners C1 and C2 (Yes), at step S21, the control device 64 starts tracking each of the paper splice parts of the mediums B1 and B2 and the top liners C1 and C2.

At step S22, at the attachment positions of the mediums B1 and B2 and the top liners C1 and C2, the control device 64 determines whether the paper splice parts of the top liners C1 and C2 precede the paper splice parts of the mediums B1 and B2. In this process, at the attachment positions of the mediums B1 and B2 and the top liners C1 and C2, if it is determined that the paper splice parts of the top liners C1 and C2 precede the paper splice parts of the mediums B1 and B2 (Yes), at step S23, the control device 64 determines whether the single-faced web splice detection unit 62 has detected the paper splice parts of the top liners C1 and C2. In this process, if it is determined that the single-faced web splice detection unit 62 has not detected all the paper splice parts of the top liners C1 and C2 (No), the control device 64 stands by as it is.

On the other hand, if it is determined that the single-faced web splice detection unit 62 has detected all the paper splice parts of the top liners C1 and C2 (Yes), at step S24, the control device 64 recalculates the lengths on bridge on the basis of the detection timing of the paper splice part of the top liners C1 and C2 by the sheet splice detection unit 61, the detection timing of the paper splice part of the top liners C1 and C2 by the single-faced web splice detection unit 62, and the conveyance speed of the top liners C1 and C2. Then, the control device 64 replaces the length on bridge calculated at step S16 to the length on bridge calculated at step S24.

Moreover, at step S22, at the attachment positions of the mediums B1 and B2 and the top liners C1 and C2, if it is determined that the paper splice parts of the top liners C1 and C2 do not precede the paper splice parts of the mediums B1 and B2 (No), the control device 64 does not recalculate the lengths on bridge.

If the lots of the top liners C1 and C2 is not changed, but only the lots of the bottom liner A and the mediums B1 and B2 are changed, the control device 64 does not recalculate the lengths on bridge at step S24. Moreover, if splicing is performed as a result of a shortage of rolls of paper of the top liners C1 and C2, instead of changing the lots of the top liners C1 and C2, the control device 64 may recalculate the lengths on bridge at step S24.

In the above description, upon starting the operation of the corrugating machine 10, the length on bridge is calculated by activating the corrugation deformation device 63, and by making the single-faced web splice detection unit 62 detect the corrugation deformed part. However, the calculation timing of the length on bridge is not limited thereto, and may be performed at any timing. In this case, calculation may be performed when the paper splice parts of the top liners C1 and C2 do not precede, or at any time by the operator.

### Effects of Present Embodiment

A device for manufacturing a corrugated cardboard according to a first aspect includes the splicers (second paper splicing devices) 31 and 32 that splice a succeeding sheet to a preceding sheet in the mediums B1 and B2; the splicers (third paper splicing devices) 33 and 34 that splice a succeeding sheet to a preceding sheet in the top liners C1 and C2; the single-faced web detection unit 62 that detects the paper splice parts of the top liners C1 and C2 based on the thicknesses of the single-faced webs D1 and D2 in which the mediums B1 and B2 and the top liners C1 and C2 are attached to one another; and the control device 64 that controls at least one of the paper splicing times of the splicers 31 and 32 and the splicers 33 and 34 such that the paper splice parts of the top liners C1 and C2 are placed on the downstream side of the paper splice parts of the mediums B1 and B2 in the sheet conveyance direction X1, at the attachment positions of the mediums B1 and B2 and the top liners C1 and C2.

With the device for manufacturing the corrugated cardboard sheet according to the first aspect, by controlling the paper splicing time by the control device 64, the paper splice parts of the top liners C1 and C2 precede the paper splice parts of the mediums B1 and B2 at the attachment positions of the mediums B1 and B2 and the top liners C1 and C2. Consequently, even if an adhesion failure of the mediums B1 and B2 and the top liners C1 and C2 occurs in the paper splice parts of the mediums B1 and B2, in the paper splice parts of the top liners C1 and C2, the mediums B1 and B2 and the top liners C1 and C2 are properly attached to one another. Then, the single-faced web splice detection unit 62 can properly detect the thicknesses of the single-faced webs D1 and D2, at the positions of the paper splice parts of the top liners C1 and C2 that precede the paper splice parts of the mediums B1 and B2. As a result, it is possible to suppress obstructed detection of the paper splice part of the second sheet, due to an adhesion failure of the mediums B1 and B2 and the top liners C1 and C2, in the paper splice parts of the top liners C1 and C2.

The device for manufacturing the corrugated cardboard according to a second aspect is the device for manufacturing the corrugated cardboard according to the first aspect, and the control device 64 further controls the paper splicing times of the splicers 31 and 33 and the splicers 32 and 34 such that the paper splice parts of the top liners C1 and C2 precede the paper splice parts of the mediums B1 and B2 by a predetermined distance set in advance, at the attachment positions of the mediums B1 and B2 and the top liners C1 and C2. Accordingly, the paper splice parts of the mediums B1 and B2 and the paper splice parts of the top liners C1 and C2 are brought close to one another within a predetermined distance. Hence, it is possible to reduce the defective length of the corrugated cardboard sheet including the paper splice parts of the mediums B1 and B2 and the paper splice parts of the top liners C1 and C2.

The device for manufacturing the corrugated cardboard according to a third aspect is the device for manufacturing the corrugated cardboard according to the first aspect or the second aspect, and the control device 64 further includes the paper splicing time setting unit 71 that sets the paper splicing times of the splicers 31 and 33 and the splicers 32 and 34, on the basis of the second distance from the splicing positions by the splicers 31 and 33 to the attachment position, the third distance from the splicing positions by the splicers 32 and 34 to the attachment position, the conveyance speeds of the mediums B1 and B2 and the top liners C1 and C2, and the corrugation ratio of the mediums B1 and B2. Accordingly, it is possible to properly set the paper splicing times of the top liners C1 and C2 by the splicers 31 and 33, and the paper splicing times of the mediums B1 and B2 by the splicers 32 and 34.

The device for manufacturing the corrugated cardboard according to a fourth aspect is the device for manufacturing the corrugated cardboard according to any one of the first aspect to the third aspect, and further includes the ultrasonic sensors (third sheet splice detection unit) 61c and 61d that detects the paper splice parts on the basis of the thicknesses of the top liners C1 and C2 on the upstream side of the attachment position in the sheet conveyance direction, the bridges 14 and 18 that retain the single-faced webs D1 and D2, and the single-faced web length-on-bridge calculation unit 73 that calculates the retention amounts of the single-faced webs D1 and D2 at the bridges 14 and 18, on the basis of the detection timings of the paper splice parts of the top liners C1 and C2 detected by the ultrasonic sensors 61c and 61d and the single-faced web splice detection unit 62. Accordingly, it is possible to calculate the retention amounts of the single-faced webs D1 and D2 at the bridges 14 and 18 with high accuracy.

The device for manufacturing the corrugated cardboard according to a fifth aspect is the device for manufacturing the corrugated cardboard according to the fourth aspect, and further includes the ultrasonic sensors (second sheet splice detection units) 61a and 61b that detect the paper splice parts on the basis of the thicknesses of the mediums B1 and B2 on the upstream side of the attachment position in the sheet conveyance direction, and the control device 64 includes the determination unit 72 that determines whether the paper splice parts of the top liners C1 and C2 precede the paper splice parts of the mediums B1 and B2. Accordingly, when the determination unit 72 determines that the paper splice parts of the top liners C1 and C2 precede the paper splice parts of the mediums B1 and B2, it is possible to properly calculate the retention amounts at the bridges 14 and 18.

The device for manufacturing the corrugated cardboard according to a sixth aspect is the device for manufacturing the corrugated cardboard according to the fifth embodiment, and the single-faced web length-on-bridge calculation unit 73 further calculates the retention amounts when the determination unit 72 determines that the paper splice parts of the top liners C1 and C2 precede the paper splice parts of the mediums B1 and B2, and the single-faced web length-on-bridge calculation unit 73 does not calculate the retention amounts when the determination unit 72 determines that the paper splice parts of the mediums B1 and B2 precede the paper splice parts of the top liners C1 and C2. Accordingly, it is possible to calculate the retention amounts at the bridges 14 and 18 with high accuracy.

The device for manufacturing the corrugated cardboard according to a seventh mode is the device for manufacturing the corrugated cardboard according to any one of the first aspect to the sixth aspect, and further includes the corrugation deformation device 63 that deforms the mediums B1 and B2 in the single-faced webs D1 and D2, and the single-faced web splice detection unit 62 can detect the corrugation deformed part deformed by the corrugation deformation device 63, and the single-faced web length-on-bridge calculation unit 73 calculates the retention amounts of the single-faced webs D1 and D2 at the bridges 14 and 18, on the basis of the deformation timing when the corrugation deformation device 63 has deformed the mediums B1 and B2, and the detection timing when the single-faced web splice detection unit 62 has detected the corrugation deformed part. Accordingly, it is possible to calculate the retention amounts at the bridges 14 and 18, without detecting the paper splice parts of the top liners C1 and C2.

A method for manufacturing a corrugated cardboard according to an eighth aspect includes a step of splicing a succeeding sheet to a preceding sheet in the mediums B1 and B2; a step device of splicing a succeeding sheet to a preceding sheet in the top liners C1 and C2; a step of controlling at least one of the paper splicing times of the mediums B1 and B2 and the top liners C1 and C2 such that the paper splice parts of the top liners C1 and C2 are placed on the downstream side of the paper splice parts of the mediums B1 and B2 in the sheet conveyance direction X1, at the attachment positions of the mediums B1 and B2 and the top liners C1 and C2; and a step of detecting the paper splice parts of the top liners C1 and C2 on the basis of the thicknesses of the single-faced webs D1 and D2 in which the mediums B1 and B2 and the top liners C1 and C2 are attached to one another. Accordingly, even if an adhesion failure of the mediums B1 and B2 and the top liners C1 and C2 occurs at the paper splice parts of the mediums B1 and B2, the mediums B1 and B2 and the top liners C1 and C2 are properly attached at the paper splice parts of the top liners C1 and C2. Then, the single-faced web splice detection unit 62 can properly detect the thicknesses of the single-faced webs D1 and D2, at the positions of the paper splice parts of the top liners C1 and C2 that precede the paper splice parts of the mediums B1 and B2. As a result, it is possible to suppress obstructed detection of the paper splice part of the second sheet, due to an adhesion failure of the mediums B1 and B2 and the top liners C1 and C2, in the paper splice parts of the top liners C1 and C2.

### REFERENCE SIGNS LIST

10 Corrugating machine (device for manufacturing corrugated cardboard)
11, 12, 15, 16, 19 Mill roll stand
13, 17 Single facer
14, 18 Bridge
20 Preheater
21 Glue machine
22 Double facer
23 Rotary shear
24 Slitter scorer
25 Cutoff
26 Waste removing device
27 Stacker
28, 29 Take-up conveyor
30 Paper guide device
31, 32 Splicer (second paper splicing device)
33, 34 Splicer (third paper splicing device)
35 Splicer (first paper splicing device)
41, 42, 43 Preheating roll
44, 45 Gluing roll
61 Sheet splice detection unit
61a, 61b Ultrasonic sensor (second sheet splice detection unit)
61c, 61d Ultrasonic sensor (third sheet splice detection unit)
61e Ultrasonic sensor
62 Single-faced web splice detection unit
62a, 62b Laser displacement sensor
63 Corrugation deformation device
63a, 63b Crushing device
64 Control device
71 Paper splicing time setting unit
72 Determination unit
73 Single-faced web length-on-bridge calculation unit
A Bottom liner (first sheet)
B1, B2 Medium (second sheet)
C1, C2 Liner (third sheet)
D1, D2 Single-faced web
E, F Single-wall corrugated cardboard

1. A device for manufacturing a corrugated cardboard to be conveyed in which a first sheet, a corrugated second sheet, and a third sheet are attached to one another, the device comprising:
a second paper splicing device that splices a succeeding sheet to a preceding sheet, which are the second sheet;
a third paper splicing device that splices a succeeding sheet to a preceding sheet, which are the third sheet;
a single-faced web splice detection unit that detects a third paper splice part of the third sheet, based on a thickness of a single-faced web in which the second sheet and the third sheet are attached to each another; and
a control device that controls at least one of paper splicing times of the second paper splicing device and the third paper splicing device so that the third paper splice part is placed on a downstream side of a second paper splice part of the second sheet in a sheet conveyance direction, at an attachment position of the second sheet and the third sheet.

2. The device for manufacturing the corrugated cardboard according to claim 1, wherein the control device controls paper splicing times of the second paper splicing device and the third paper splicing device so that the third paper splice part precedes the second paper splice part by a predetermined distance set in advance at the attachment position.

3. The device for manufacturing the corrugated cardboard according to claim 1, wherein the control device includes a splice timing setting unit that sets the paper splicing times of the second paper splicing device and the third paper splicing device, based on a second distance that is from a second splicing position by the second paper splicing device to the attachment position, a third distance that is from a third splicing position by the third paper splicing device to the attachment position, conveyance speeds of the second sheet and the third sheet, and a corrugation ratio for the second sheet.

4. The device for manufacturing the corrugated cardboard according to claim 1, further comprising:
a third sheet splice detection unit that detects the third paper splice part based on a thickness of the third sheet on an upstream side of the attachment position in the sheet conveyance direction;
a bridge that retains the single-faced web; and
a single-faced web length-on-bridge calculation unit that calculates a retention amount of the single-faced web at the bridge, based on detection timing of the third paper splice part that is detected by the third sheet splice detection unit and the single-faced web splice detection unit.

5. The device for manufacturing the corrugated cardboard according to claim 4, further comprising a second sheet splice detection unit that detects the second paper splice part, based on a thickness of the second sheet on an upstream side of the attachment position in the sheet conveyance direction,
wherein the control device includes a determination unit that determines whether the third paper splice part precedes the second paper splice part.

6. The device for manufacturing the corrugated cardboard according to claim 5, wherein
when the determination unit determines that the third paper splice part precedes the second paper splice part, the single-faced web length-on-bridge calculation unit calculates the retention amount, and
when the determination unit determines that the second paper splice part precedes the third paper splice part, the single-faced web length-on-bridge calculation unit does not calculate the retention amount.

7. The device for manufacturing the corrugated cardboard according to claim 4, further comprising a corrugation deformation device that deforms the second sheet in the single-faced web, wherein
the single-faced web splice detection unit is capable of detecting a corrugation deformed part deformed by the corrugation deformation device, and
the single-faced web length-on-bridge calculation unit calculates the retention amount of the single-faced web at the bridge, based on deformation timing when the corrugation deformation device has deformed the second sheet, and detection timing when the single-faced web splice detection unit has detected the corrugation deformed part.

8. A method for manufacturing a corrugated cardboard that manufactures a corrugated cardboard in which a first sheet, a corrugated second sheet, and a third sheet are attached to one another, the method comprising the steps of:
splicing a succeeding sheet to a preceding sheet, which are the second sheet;
splicing a succeeding sheet to a preceding sheet, which are the third sheet;
controlling at least one of paper splicing times of the second sheet and the third sheet so that a third paper splice part of the third sheet is placed on a downstream side of a second paper splice part of the second sheet in a sheet conveyance direction, at an attachment position of the second sheet and the third sheet; and
detecting the third paper splice part based on a thickness of a single-faced web in which the second sheet and the third sheet are attached to each another.

9. The device for manufacturing the corrugated cardboard according to claim 2, wherein the control device includes a splice timing setting unit that sets the paper splicing times of the second paper splicing device and the third paper splicing device, based on a second distance that is from a second splicing position by the second paper splicing device to the attachment position, a third distance that is from a third splicing position by the third paper splicing device to the attachment position, conveyance speeds of the second sheet and the third sheet, and a corrugation ratio for the second sheet.
